(19) United States
(12) Patent Application Publication
(10) Pub. No.: US 2007/0026365 A1
(43) Pub. Date: Feb. 1, 2007

(54) Defining virtual patient populations

(75) Inventors: Christina Maria Friedrich, San Francisco, CA (US); Anuraag Kansal, Baltimore, MD (US); David Klinke, Morgantown, WV (US); Seth G. Michelson, San Jose, CA (US); Thomas Paterson, Redondo Beach, CA (US); David Polidori, Racho Santa Fe, CA (US); Jeff Trimmer, Burlingame, CA (US); Leif Gustaf Wennerberg, Mountain View, CA (US)

Correspondence Address: ENTELOS, INC.;c/o FOLEY & LARDNER LLP, 1530 PAGE MILL RD., PALO ALTO, CA, 94304, US

(73) Assignee: Entelos, Inc.

(21) Appl. No.: 11/346,990

(22) Filed: Feb. 3, 2006

Related U.S. Application Data
(60) Provisional application No. 60/649,964, filed on Feb. 4, 2005.

(51) Int. Cl. G09B 19/00

(52) U.S. Cl. 434/127

(57) ABSTRACT

The invention encompasses methods, including computer-implemented methods, of defining a virtual patient population and mapping the virtual patient population to a population of real patients. The invention utilizes virtual measures from one or more virtual patients, and data representative of multiple real subjects in a sample population, such as data collected from patients in a clinical trial or epidemiological study of a real population. The invention includes evaluating the similarity between the virtual patients and the real subjects, and assigning prevalences to the virtual patients based on the evaluation. The similarity can be assessed using some or all of the virtual measures of the virtual patients and some or all of the data obtained for the real subjects. Any of various goodness-of-fit measures can be used to evaluate the similarity or to help identify prevalences. The virtual patient population is defined as the virtual patients according to their respective prevalences.

### CROSS-REFERENCE TO RELATED APPLICATIONS

This application claims the benefit of U.S. Provisional Application No. 60/649,964, filed 4 Feb. 2005, incorporated herein by reference in its entirety.

### I. INTRODUCTION

1. Field of the Invention

This invention relates to research involving virtual and actual populations.

2. Background of the Invention

The development of safe and effective treatments for disease is a primary goal of modern medicine. Information about real populations may, however, be limited and difficult to obtain. Clinical trials, for example, are key in establishing the safety and efficacy of potential new drugs but they can be extremely costly and typically provide limited information about the relationships between the occurrence, etiology, and effective treatment of disease. Developments in computer-based studies of biology, on the other hand, are providing patients and physicians with a rapidly growing source of data relating to the biological systems underlying the occurrence and pathophysiology of disease.

Such in silico models of biological systems are relatively inexpensive and offer unlimited opportunities for virtual experimentation. Indeed, computer-based biological simulations have been used to explore a wide variety of fundamental biological processes and to inform our understanding and treatment of disease. Such simulations can, for example, help identify the relationships among biological systems involved in a disease state such as diabetes, or the cellular processes occurring, for example, in prion diseases. They can help design drugs that will bind to or block known receptors. Such efforts provide a rich source of information that can be relevant to understanding of a disease and evaluation of its possible treatments.

Computer models known as clinical decision support systems (CDSS) can help physicians use information gained from studies of real populations. For example, a clinical decision support system called Archimedes uses such data to simulate the complete healthcare environment. Archimedes characterizes the interactions between every person, every doctor, and every piece of equipment using data from epidemiological and clinical trial studies. Given a certain set of demographics, it can then make population level predictions about the progression of a disease and the prospective advantages of interventions such as establishing preventive behaviors, improving diagnosis, and screening, providing better care management, or otherwise changing patient and practitioner behaviors. Eddy and Schlessinger, Diabetes Care 26:3093-3101 (2003) and Eddy and Schlessinger, Diabetes Care 26:3102-3110 (2003).

Clinical trials have been simulated using descriptive statistical summaries of extant patient populations, typically those drawn from pilot clinical trials. For example, PHARSIGHT, uses multivariate statistical techniques (e.g., NONMEM) to identify, post hoc, covariate relationships and/or obvious blocking factors (e.g., gender, smoking status, etc.) in the response profiles of the pilot study population. Based on these descriptive measures of patient response, a simulation team can then use Monte Carlo simulation technologies to run, in silico, mock clinical trials. The output of the simulated trials is a single clinical trial design in which patient prevalence is implicitly derived from the random sampling scheme underlying the Monte Carlo methodology.

Such decision support systems can help identify interventions that might affect the incidence of disease in a community based on existing studies of real populations. But such models do not permit population level inferences that reflect the wealth of knowledge gained by models of the underlying mechanisms of disease or the dynamics of biological characteristics and processes contributing to the disease.

It is desirable to have a method that permits the use of simulations of individual patients to be used to access, characterize, or predict features of a real population.

### SUMMARY OF THE INVENTION

In one aspect, the invention provides methods for defining a virtual patient population. A datum or data for each of multiple real subjects in a sample population is obtained. Simulated measures for each of two or more virtual patients are acquired. Similarity between the virtual patients and the real subjects is evaluated using a subset of the datum or data for at least two of the real subjects and a subset of the simulated measures for at least two of the virtual patients. Each subset characterizes one or more features common to the at least two real subjects and the at least two virtual patients. A prevalence is assigned to each virtual patient based on the evaluation. The virtual patient population is defined as the two or more virtual patients according to their respective prevalences.

Advantageous implementations of the methods can include one or more of the following features. The simulated measures for each of two or more virtual patients can be acquired by using a model of a biological system to generate one or more simulated measures for each of the two or more virtual patients. The subset can be all of the simulated measures or all of the data. A prevalence of zero can be assigned to at least one virtual patient. A cluster of two or more virtual patients can be identified, and a same prevalence can be assigned to each of the two or more virtual patients in the cluster. A datum or data for each of the multiple real subjects can be associated with one or more of the simulated measures for each of the virtual patients to identify features common to the virtual patients and the real subjects.

The common features can include one or more independent variables and one or more dependent variables. The one or more dependent variables can include measurements of a biological feature at multiple time intervals. The common features can include multiple independent or dependent variables, wherein at least one variable is a continuous variable. The common features can include one or more categorical variables.

The similarity between the virtual patients and the real subjects can be evaluated by identifying one or more combinations of the common features and characterizing each of the virtual patients and the real subjects in terms of the combinations. The combinations can be identified using a principle components analysis to identify principle components, and the virtual patients and the real subjects can be characterized by locating each of the virtual patients and the real subjects in a space defined by the principle components or by factors derived from the principle components. The similarity between the two or more virtual patients and the real subjects can be evaluated by identifying one or more combinations of the common features that separate real patients according to a vector of independent variables.

The similarity between the two or more virtual patients and the real subjects can be evaluated by determining a correlation between the independent variables and the dependent variables for the real subjects, determining the correlation between the independent variables and the dependent variables for the virtual patients, and comparing the correlation for the real subjects with the correlation for the virtual patients. The dependent variables can be expressed as a first function of the independent variables using data from the real subjects; the dependent variables can be expressed as a second function of the independent variables using data defining the virtual patients; and the first and second functions can be compared. The first function can be a first linear regression; the second function can be a second linear regression; and a slope of the first linear regression can be compared with a slope of the second linear regression. Assigning a prevalence to each virtual patient can include adjusting the parameters of the correlation for the virtual patients to more closely approximate the correlation for the real subjects.

The similarity between the virtual patients and the real subjects can be evaluated by identifying two or more clusters of real subjects and assigning each of the virtual patients to one of the two or more clusters. Two or more clusters of real subjects can be identified, and a distance between each of the virtual patients and each of the two or more clusters of real subjects can be calculated. Assigning a prevalence to each virtual patient can include computing a weight based on the number and similarity of real subjects determined to be within a similarity threshold.

The common features can include at least one continuous dependent variable, and evaluating the similarity between the virtual patients and the real subjects can include calculating one or more summary statistics for the continuous dependent variable for the real subjects and for the continuous dependent variable for the virtual patients, and comparing the one or more summary statistics for the real subjects with the summary statistics for the virtual patients. The summary statistics can include a measure of mean, mode, standard deviation, variance, skewness, or kurtosis for the continuous dependent variable.

To evaluate similarity, a measure of goodness-of-fit between the common features for the virtual patients and the common features for the real subjects can be calculated. A measure of goodness-of-fit between the combinations of the common features for the virtual patients and the combinations of the common features for the real subjects can be calculated. The measure of goodness-of-fit can be a Chi-square test, G-test, Analysis of Covariance (ANCOVA), Kolmogorov-Smimov test, weighted coefficient of determination. The measure of goodness-of-fit can be a qualitative assessment of statistical properties of the common features for the virtual patients and the common features for the real subjects.

Assigning a prevalence to each virtual patient can include matching each of the two or more virtual patients to one or more real subjects, assigning a matching score to each of the two or more virtual patients based upon the matches, and computing a prevalence for each virtual patient based upon its matching score. Each matching score can be based on a measure of distance between a virtual patient and a real subject in a space defined by the common features. The measure of distance can weight the common features differently. Each matching score can be based on the distance between a virtual patient and a real subject in a space defined by the principle components or by factors derived from the principal components. Matching each of the virtual patients to one or more real subjects can include determining, for each of the two or more virtual patients, a distance to each of the one or more real subjects; assigning a matching score to each of the two or more virtual patients can include, for each real subject, normalizing the distances of the virtual patients that match the real subject to define a normalized per subject distance and, for each virtual patient, summing the normalized per subject distances to define a virtual patient total score; and computing a prevalence can include normalizing the total scores for the two or more virtual patients.

Advantageous implementations of the methods can further include one or more of the following features. Similarity between the virtual patient population and the sample population can be evaluated using the common features. A new prevalence can be assigned to each virtual patient based on the similarity between the virtual patient population and the sample population. The virtual patient population can be re-defined as the two or more virtual patients according to their respective new prevalences.

Similarity can be evaluated using a measure of goodness-of-fit between the common features for the virtual patients according to their respective prevalences and the common features for the real subjects. The measure of goodness-of-fit can be a Chi-square test, G-test, Analysis of Covariance (ANCOVA), Kolmogorov-Smimov test, weighted coefficient of determination. The measure of goodness-of-fit can be a qualitative review of the statistical properties of the common features for the virtual patients and the real subjects.

The common features can include at least one continuous dependent variable and similarity can be evaluated by calculating one or more summary statistics for the continuous dependent variable for the real subjects, calculating the one or more summary statistics for the continuous dependent variable for the virtual patients according to their respective prevalences, and comparing the one or more summary statistics for the real subjects with the summary statistics for the virtual patients.

Another aspect of the invention provides a method for defining a virtual patient population. A datum or data is obtained for each of multiple real subjects in a sample population. One or more simulated measures are acquired for one or more virtual patients. Similarity between the one or more virtual patients and the real subjects is evaluated using a subset of the datum or data for at least two of the real subjects and a subset of the simulated measures for at least one of the virtual patients. Each subset characterizes one or more features common to the at least two real subjects and the at least one virtual patient. One or more additional virtual patients are built based on the evaluation and similarity between the one or more virtual patients together with the one or more additional virtual patients and the real subjects is re-evaluated using the common features. A prevalence is assigned to each virtual patient based on the re-evaluation. The virtual patient population is defined as the two or more virtual patients according to their respective prevalences.

Advantageous implementations of the methods can include one or more of the following features. Building one or more additional virtual patients based on the evaluation can include identifying hypothetical values of the common features that have high similarity to one or more real subjects and low similarity to one or more virtual patients, and generating simulated measures for one or more additional virtual patients, wherein the simulated measures are similar to the hypothetical values. The steps of building one or more additional virtual patients based on the evaluation and evaluating similarity between the one or more virtual patients together with the one or more additional virtual patients and the real subjects using the common features can be repeated one or more times. A prevalence can be assigned to each virtual patients based on the re-evaluation.

The similarity between the virtual patient population and the sample population can be evaluated using a new subset of the datum or data for at least two of the real subjects and a new subset of the simulated measures for at least two of the virtual patients, where each new subset characterizes one or more different features common to the at least two real subjects and the at least two virtual patients. A new prevalence can be assigned to each virtual patient based on the similarity between the virtual patient population and the sample population using the different common features. The virtual patient population can be redefined as the two or more virtual patients according to their respective new prevalences.

It will be appreciated by one of skill in the art that the embodiments summarized above may be used together in any suitable combination to generate additional embodiments not expressly recited above, and that such embodiments are considered to be part of the present invention

### II. BRIEF DESCRIPTION OF THE FIGURES

For a better understanding of the nature and objects of some embodiments of the invention, reference should be made to the following detailed description taken in conjunction with the accompanying drawings, in which:

FIG. 1 describes a method for defining a virtual patient population.

FIG. 2 describes a method for defining a virtual patient population that includes building additional virtual patients.

FIG. 3 describes a method for defining a virtual patient population that includes optional steps of identifying new common features and evaluating similarity between the virtual patient population and the sample population.

FIG. 4 illustrates the use of a mechanistic model of several biological systems to define five different virtual patients.

FIG. 5 illustrates a population having five different types of real subjects, a sample population having five different types of real subjects in frequencies similar to the population, and a virtual patient population with five types of virtual patients each analogous to one of the types of real subjects and weighted to occur with prevalences similar to the frequencies of occurrence of its corresponding real subject type.

FIG. 6 is a histogram showing cross-sectional variability in the values of features for a sample population of real subjects.

FIG. 7 is a graph showing a dynamic trajectory of longitudinal data for two real subjects.

FIG. 8 presents two histograms, each showing cross-sectional variability in the values of features for a sample population of real subjects, the two histograms together demonstrating longitudinal variability.

FIG. 9 shows plots of virtual patients and real subjects in a two-dimensional space defined by factors 1 and 4 from a factor analysis and a two-dimensional space defined by factors 2 and 3 from the factor analysis.

FIG. 10 plots virtual patients as a function of factors 1, 2, and 3, and shows spheres enclosing an expected 10%, 25%, and 75% of the virtual patients.

FIG. 11 is a histogram of values for real subjects, showing an analytical expression of the distribution of values, and a histogram of values for each of two sets of virtual patients, also showing the analytical expression of the distribution of values.

FIG. 12 is a plot showing how some virtual patients are over-represented, and need to be down-weighted, and some are under-represented and need to be up-weighted.

FIG. 13 is an exemplary plot of virtual patient values, showing the prevalence of each measure among the virtual patients, and a plot of prevalences of the virtual patients.

### III. DETAILED DESCRIPTION

A. Overview

This specification describes methods, including computer-implemented methods, of defining a virtual patient population and mapping the virtual patient population to a population of real patients. The invention begins with one or more virtual patients having virtual measures, for example from a model of a biological system, and multiple subjects in a sample population for which there are data representative of real subjects in a population, for example data collected from patients in a clinical trial or an epidemiological study of a real population. The invention includes evaluating the similarity between the virtual patients and the real subjects, and assigning prevalences to the virtual patients based on the evaluation. The similarity can be assessed for features that are common to at least some of the virtual patients and some of the real subjects, using some or all of the virtual measures of the virtual patients and some or all of the data obtained for the real subjects. Any of various goodness-of-fit measures can be used to evaluate the similarity or to help identify prevalences. The virtual patient population is defined as the virtual patients according to their respective prevalences. The invention also encompasses building additional virtual patients based on the evaluation of similarity of virtual patients and real subjects.

B. Definitions

The term “population,” as used herein, refers to a group or collection of individuals, either real or virtual. The individuals in the collection of individuals can be from or represent, for example, a group of subjects having a particular disease, treatment history, physiologic or genotypic characteristic(s), and the like. A population is typically a collection of individuals about which one wants to generalize, e.g., the inhabitants of Greenland, cancer patients receiving chemotherapy, severe diabetics, hypertensive rats, etc. The population is typically comprised of mammals of a similar species, e.g. humans.

The term “sample population,” as used herein, refers to a subset of individuals in a population. The sample population can be, for example, the set of individuals participating in a clinical trial. Ideally, a sample population is representative of the population, for example because individuals in the sample population were selected at random from the population, such that observations based upon analysis of the sample population apply to the population as a whole. A sample population can be any small fraction, any moderate fraction, any large fraction, or the entirety of a population.

The term “population characteristics,” as used herein, refers to any qualitative or quantitative features, behaviors, or aspects of the population that are of interest. For example, if the population is cancer patients receiving chemotherapy, the population characteristics may include tumor mass, five-year survival rate, red blood cell (“RBC”) count, and white blood cell (“WBC”) count; if the population is severe diabetics, the population characteristics may include fasting glucose, HbAlc, circulating free fatty acids (“FFA”) concentrations; and if the population is hypertensive rats, the population characteristics may include mean arterial pressure (“MAP”), diastolic blood pressure (“DBP”), systolic blood pressure (“SBP”).

The term “virtual patient,” as used herein, refers to a hypothetical subject, typically a human, including information that is used in and produced by a computer simulation of the hypothetical subject. The computer simulation can be mechanistic or phenomenological in nature. The hypothetical subject can be represented by defining a set of state variables, which can be potentially indicative of or associated with a particular hypothetical physiologic state or condition. The state variables can be determined in whole or in part by models of particular biological systems, processes, or mechanisms. The representation can be, for example, a mathematically explicit vector of parameter values used, for example, in a simulation with a mechanistic model as with the systems described in co-pending U.S. patent applications bearing publication Nos. 2003/0014232, 2003/0058245, 2003/0078759, and 2003/0104475.

The term “real subject,” as used herein, refers to an actual and existing individual, typically a human and possibly a patient, as distinguished from a virtual patient.

The term “virtual patient population,” as used herein, represents the population characteristics of a population of real subjects, such as a clinical population of interest. The virtual patient population has statistical properties or behaviors (e.g., mean, median, variance, dynamics, etc.) that approximate the statistical properties or behavior of a sample population of real subjects.

The term “prevalence,” as used herein to describe a virtual patient, indicates the occurrence, e.g. the frequency of occurrence, of that virtual patient in a virtual patient population. The prevalence of any particular virtual patient in a virtual patient population can be defined by a weighting factor or weight, wherein each weight adjusts for over- or under-representation of the characteristics of the virtual patient in the population. The prevalence of a virtual patient relates to the likelihood that there is a real subject in the population with characteristics of or similar to the virtual patient.

The term “goodness-of-fit,” as used herein, refers to the similarity of two or more distributions, such as a prediction or simulation compared to an actual observation. Measures of goodness-of-fit include any method or process by which one quantifies and/or qualifies such similarity. Qualitative measures include visual inspection and comparison of plots or other graphical representations of the distributions. Quantitative measures include statistically rigorous methods by which one quantifies the total deviation of one set of values from another, for example, using a Chi-square test, G-test, Analysis of Covariance (ANCOVA), or Kolmogorov-Smimov test. Measures of goodness-of-fit can include both qualitative and quantitative aspects, such as non-parametric measures including ranked or categorized pairwise comparisons.

The term “mechanistic model,” as used herein, refers to a computational model, for example a model having a set of differential equations, that describes the characteristics or behavior of a system, for example, a biological system. Mechanistic models can be causal models, which typically link two or more causally-related variables in a mathematical relationship that reflects the underlying mechanism(s), for example the biological mechanisms, affecting those variables.

The term “biological system,” as used herein, refers to any system of interacting or potentially interacting biological constituents whose behavior can be characterized in whole or part by one or more biological processes or mechanisms. A biological system can include, for example, an individual cell, a collection of cells such as a cell culture, an organ, a tissue, a multi-cellular organism such as an individual human patient, a subset of cells of a multi-cellular organism, or a population of multi-cellular organisms such as a group of human patients or the general human population as a whole. A biological system can also include, for example, a multi-tissue system such as the nervous system, immune system, or cardio-vascular system.

The term “biological constituent,” as used herein, refers to a portion of a biological system. A biological constituent that is part of a biological system can include, for example, an extra-cellular constituent, a cellular constituent, an intra-cellular constituent, or a combination of them. Examples of biological constituents include DNA; RNA; proteins; enzymes; hormones; cells; organs; tissues; portions of cells, tissues, or organs; subcellular organelles such as mitochondria, nuclei, Golgi complexes, lysosomes, endoplasmic reticula, and ribosomes; and chemically reactive molecules such as H⁺, superoxides, ATP, citric acid, protein albumin, and combinations of them.

The term “cellular constituent,” as used herein, refers to a biological cell or a portion thereof. Nonlimiting examples of cellular constituents include molecules such as DNA, RNA, proteins, glycoproteins, lipoproteins, sugars, fatty acids, enzymes; hormones, and chemically reactive molecules (e.g., H+; superoxides, ATP, and citric acid); macromolecules and molecular complexes; cells and portions of cells, such as subcellular organelles (e.g., mitochondria, nuclei, Golgi complexes, lysosomes, endoplasmic reticula, and ribosomes); and combinations thereof.

The term “biological process,” as used herein, refers to an interaction or set of interactions between biological constituents of a biological system. In some instances, a biological process can refer to a set of biological constituents drawn from some aspect of a biological system together with a network of interactions between the biological constituents. Biological processes can include, for example, biochemical or molecular pathways. Biological processes can also include, for example, pathways that occur within or in contact with an environment of a cell, organ, tissue, or multi-cellular organism. Examples of biological processes include biochemical pathways in which molecules are broken down to provide cellular energy, biochemical pathways in which molecules are built up to provide cellular structure or energy stores, biochemical pathways in which proteins or nucleic acids are synthesized or activated, and biochemical pathways in which protein or nucleic acid precursors are synthesized. Biological constituents of such biochemical pathways include, for example, enzymes, synthetic intermediates, substrate precursors, and intermediate species.

Biological processes can also include, for example, signaling and control pathways. Biological constituents of such pathways include, for example, primary or intermediate signaling molecules as well as proteins participating in signaling or control cascades that usually characterize these pathways. For signaling pathways, binding of a signaling molecule to a receptor can directly influence the amount of intermediate signaling molecules and can indirectly influence the degree of phosphorylation (or other modification) of pathway proteins. Binding of signaling molecules can influence activities of cellular proteins by, for example, affecting the transcriptional behavior of a cell. These cellular proteins are often important effectors of cellular events initiated by a signal. Control pathways, such as those controlling the timing and occurrence of cell cycles, share some similarities with signaling pathways. Here, multiple and often ongoing cellular events are temporally coordinated, often with feedback control, to achieve an outcome, such as, for example, cell division with chromosome segregation. This temporal coordination is a consequence of the functioning of control pathways, which are often mediated by mutual influences of proteins on each other's degree of modification or activation (e.g., phosphorylation). Other control pathways can include pathways that can seek to maintain optimal levels of cellular metabolites in the face of a changing environment.

Biological processes can be hierarchical, non-hierarchical, or a combination of hierarchical and non-hierarchical. A hierarchical process is one in which biological constituents can be arranged into a hierarchy of levels, such that biological constituents belonging to a particular level can interact with biological constituents belonging to other levels. A hierarchical process generally originates from biological constituents belonging to the lowest levels. A non-hierarchical process is one in which a biological constituent in the process can interact with another biological constituent that is further upstream or downstream. A non-hierarchical process often has one or more feedback loops. A feedback loop in a biological process refers to a subset of biological constituents of the biological process, where each biological constituent of the feedback loop can interact with other biological constituents of the feedback loop.

The term “biological mechanism,” as used herein, refers to an underlying biological, e.g. physiological, process that gives rise to a clinically observable characteristic or behavior. Biological mechanisms may incorporate or be based on biological processes such as, e.g., the binding of a drug to a receptor (including, e.g., the binding constant); the catalysis of a particular chemical reaction, e.g., an enzymatic reaction (including, e.g., the rate of such a reaction); the synthesis or degradation of a cellular constituent, such as a molecule or molecular complex (including, e.g., the rate of such synthesis or degradation); the modification of a cellular constituent, such as the phosphorylation or glycosylation of a protein (including, e.g., the rate of such phosphorylation or glycosylation); and the like. A biological mechanism also can involve an interaction of one biological constituent with another, for example, a synthetic transformation of one biological constituent into the other, a direct physical interaction of the biological constituents, an indirect interaction of the biological constituents mediated through intermediate biological events, or some other mechanism. An interaction of one biological constituent with another can include, for example, a regulatory modulation of one biological constituent by another, such as an inhibition or stimulation of a production rate, a level, or an activity of one biological constituent by another, and may constitute a biological system's synthetic, regulatory, homeostatic, or control networks. A biological mechanism can be known or unknown.

The term “biological state,” as used herein, refers to a condition associated with a biological system, for example the state of a biological constituent. In some instances, a biological state refers to a condition associated with the occurrence of a set of biological processes of a biological system. Each biological process of a biological system can interact according to some biological mechanism with one or more additional biological processes of the biological system. As the biological processes change relative to each other, a biological state typically also changes. A biological state typically depends on various biological mechanisms by which biological processes interact with one another. A biological state can include, for example, a condition of a nutrient or hormone concentration in plasma, interstitial fluid, intracellular fluid, or cerebrospinal fluid. For example, biological states associated with hypoglycemia and hypoinsulinemia are characterized by conditions of low blood sugar and low blood insulin, respectively. These conditions can be imposed experimentally or can be inherently present in a particular biological system. As another example, a biological state of a neuron can include, for example, a condition in which the neuron is at rest, a condition in which the neuron is firing an action potential, a condition in which the neuron is releasing a neurotransmitter, or a combination of them. As a further example, biological states of a collection of plasma nutrients can include a condition in which a person awakens from an overnight fast, a condition just after a meal, and a condition between meals. As another example, the biological state of a rheumatic joint can include significant cartilage degradation and hyperplasia of inflammatory cells.

A biological state can include a “disease state,” which, as used herein, refers to an abnormal or harmful condition associated with a biological system. A disease state is typically associated with an abnormal or harmful effect of a disease in a biological system. In some instances, a disease state refers to a condition associated with the occurrence of a set of biological processes of a biological system, where the set of biological processes play a role in an abnormal or harmful effect of a disease in the biological system. A disease state can be observed in, for example, a cell, an organ, a tissue, a multi-cellular organism, or a population of multi-cellular organisms. Examples of disease states include conditions associated with asthma, diabetes, obesity, and rheumatoid arthritis.

The term “drug,” as used herein, refers to a compound of any degree of complexity that can affect a biological state, whether by known or unknown biological processes or mechanisms, and whether or not used therapeutically. In some instances, a drug exerts its effects by interacting with a biological constituent, which can be referred to as a therapeutic target of the drug. Examples of drugs include typical small molecules of research or therapeutic interest; naturally-occurring factors such as endocrine, paracrine, or autocrine factors or factors interacting with cell receptors of any type; intracellular factors such as elements of intracellular signaling pathways; factors isolated from other natural sources; pesticides; herbicides; and insecticides. Drugs can also include, for example, agents used in gene therapy like DNA and RNA. Also, antibodies, viruses, bacteria, and bioactive agents produced by bacteria and viruses (e.g., toxins) can be considered as drugs. For certain applications, a drug can include a composition including a set of drugs or a composition including a set of drugs and a set of excipients.

C. General Methodology

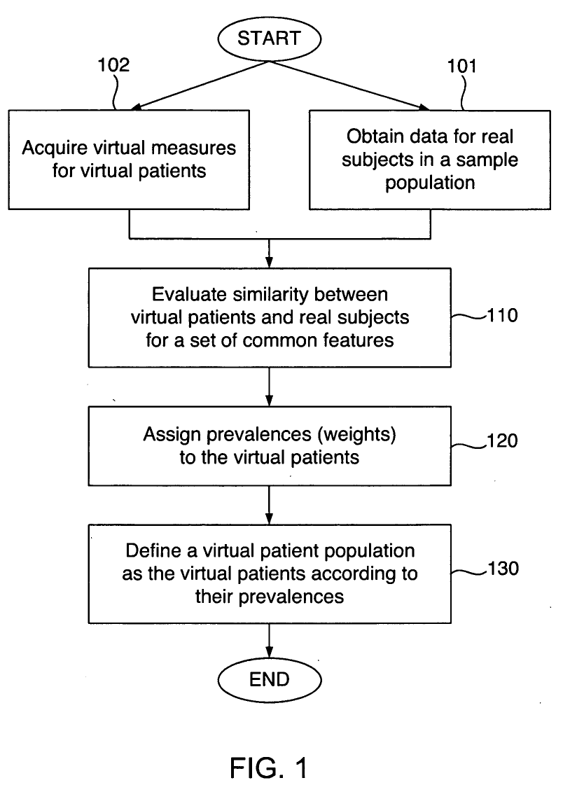

As shown in FIG. 1, a method for defining a virtual patient population requires acquiring virtual measures for virtual patients (step 102) and obtaining data for real subjects in a sample population (step 101). Virtual measures can be acquired, for example, from a simulation of a biological system for one or more virtual patients, where the virtual patients are characterized by input and output variables. Data for real subjects can be obtained, for example, from established databases (e.g. the NHANES III database), clinical trials, the published literature, or private research efforts. Similarity between the virtual patients and the real subjects is evaluated for some number of common features (step 110). Methods for evaluating similarity are discussed in more detail below. The common features can be identified by inspection of the virtual measures and data. The common features are biological variables or parameters for which information is available for at least some of the virtual patients and some of the real subjects. Preferably, there are virtual measures for each virtual patient for each of the common features, and data for each real subject for each of the common features. The evaluation of similarity between the virtual patients and real subjects for the common features is used to assign prevalences to the virtual patients (step 120). Methods for assigning prevalences are also discussed in more detail below. The virtual patient population is defined as the virtual patients according to their prevalences (step 130).

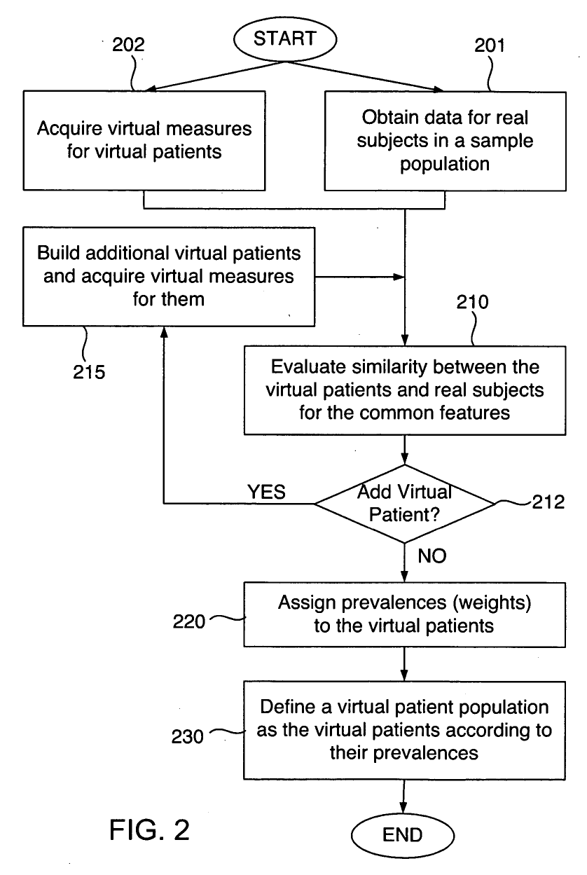

As shown in FIG. 2, a method for defining a virtual patient population can include the step of building additional virtual patients (step 215). The method shown in FIG. 2 requires acquiring virtual measures for at least one virtual patient (step 202) and obtaining data for real subjects in a sample population (step 201). Virtual measures can be acquired and data can be obtained as discussed with respect to the method shown in FIG. 1. Similarity between the virtual patients and the real subjects is evaluated for some number of common features (step 210), also as discussed with respect to the method shown in FIG. 1 and in more detail below. After evaluating the similarity between the one or more virtual patients and the real subjects, additional virtual patients can be identified for possible inclusion in the virtual patient population (the “yes” branch of step 212).

For example, additional virtual patients can be built to resemble particular real subjects. Also for example, additional virtual patients can be identified to fill in gaps in the distribution of values of the features for the virtual patients compared to the values of the features for the real subjects. To build one or more additional virtual patients (step 215), hypothetical values of one or more of the common features can be identified and used to generate virtual measures for one or more additional virtual patients. The hypothetical values will typically have higher similarity to one or more real subjects and lower similarity to one or more virtual patients. Virtual measures for the additional virtual patients are added to the virtual measures for the one or more virtual patients acquired in step 202, and similarity between the expanded collection of virtual patients and the real subjects is evaluated (step 210), typically for the same common features as were evaluated previously. More virtual patients can be added (the “yes” branch of step 212). For example, if there are still gaps in the distribution of values of the features for the virtual patients compared to the distribution of values of the features for the real subjects, additional virtual patients can be built and added to the collection of virtual patients (step 215). Similarity between the new collection of virtual patients and real subjects is then evaluated again (step 212).

When the similarity of the virtual patients and real subjects is satisfactory (the “no” branch of step 212), one or more of the evaluations of similarity between the virtual patients and real subjects for the common features is used to assign prevalences to the virtual patients (step 220), as discussed with respect to the method shown in FIG. 1 and in more detail below. The virtual patient population is defined as the virtual patients according to their prevalences (step 230).

A method for defining a virtual patient population can include repetition of various of the steps identified in FIGS. 1 and 2. For example, a method for defining a virtual patient population can include identifying features common to the virtual patients and the real subjects and then identifying new features common to the virtual patients and the real subjects, for example, after evaluating similarity between the virtual patients and the real subjects for the common features. Also for example, a method for defining a virtual patient population can include evaluating similarity between the virtual patients and the real subjects for some the common features and assigning prevalences to the virtual patients, and then evaluating similarity between the virtual patient population (i.e. the virtual patients according to their prevalences) and the real subjects. New prevalences can be assigned based, for example, on the evaluation of similarity between the virtual patient population and the real subjects.

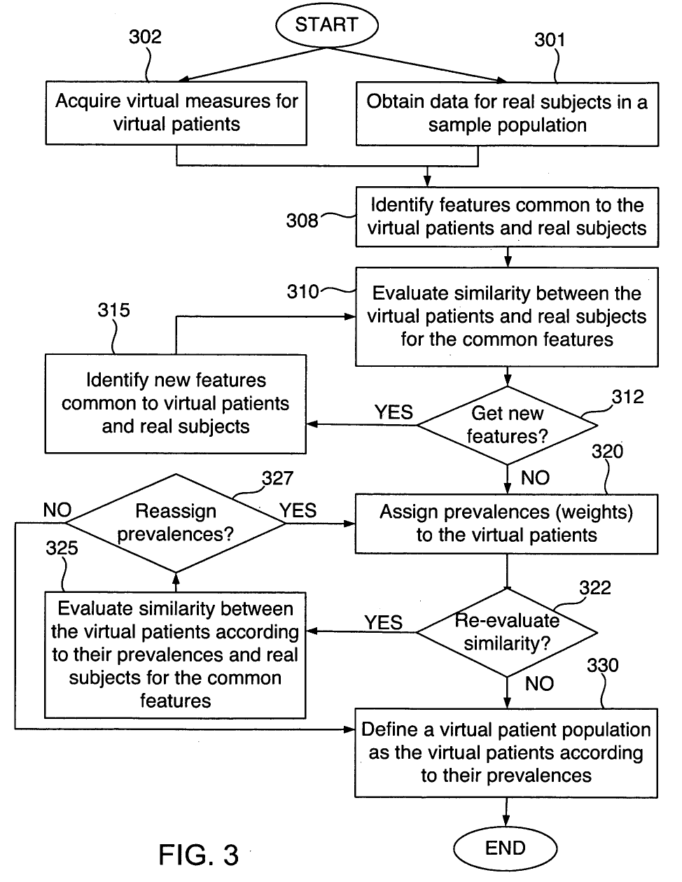

A method for defining a virtual patient population that includes optional repetition of some steps is shown in FIG. 3. The method shown in FIG. 3 requires acquiring virtual measures for at least one virtual patient (step 302) and obtaining data for real subjects in a sample population (step 301). Virtual measures can be acquired and data can be obtained as discussed with respect to the method shown in FIG. 1. Features common to the virtual patients and the real subjects are identified (step 308). Similarity between the virtual patients and the real subjects is evaluated for the common features (step 310), also as discussed with respect to the method shown in FIG. 1 and in more detail below. If new common features are desired (the “yes” branch of step 312), new common features are identified (step 315) and step 310 is repeated. If new common features are not desired (the “no” branch of step 312), the evaluation of similarity between the virtual patients and real subjects for the common features is used to assign prevalences to the virtual patients (step 320). Methods for assigning prevalences are discussed in more detail below. If desired (the “yes” branch of step 322), similarity between the virtual patients according to their prevalences and the real subjects can be evaluated (step 325). Then, if desired (the “yes” branch of step 327), new prevalences can be assigned to the virtual patients based on the evaluation of similarity between the virtual patients according to their prevalences and the real subjects. Alternatively (the “no” branch of step 327 and the “no” branch of step 322) the virtual patient population is defined as the virtual patients according to their previously defined prevalences (step 330).

D. Virtual Patients

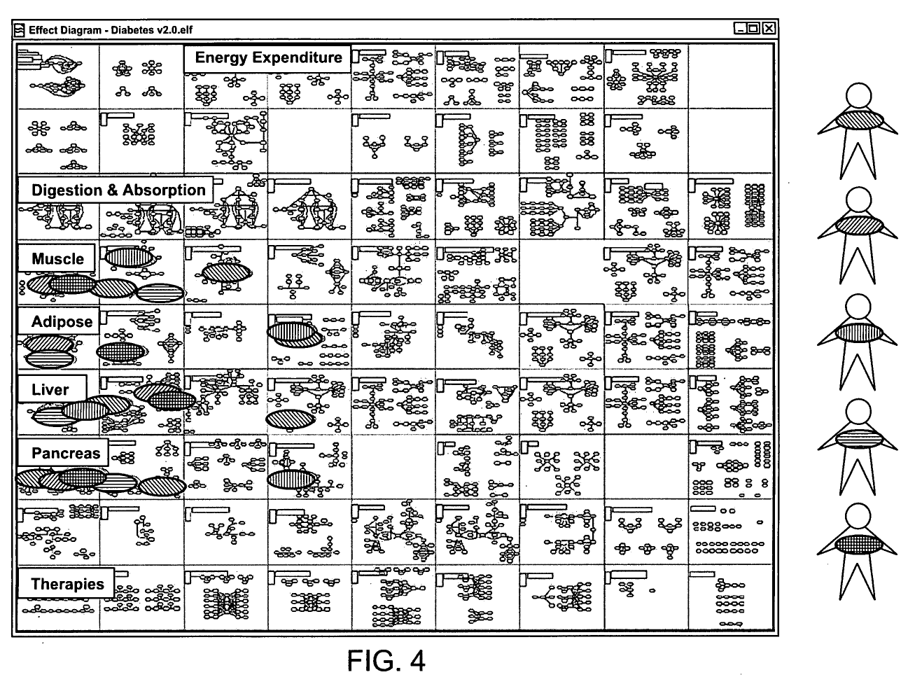

A virtual patient, as defined more fully above, refers to a representation of the features of a hypothetical subject. A virtual patient can be represented by defining a set of features of the virtual patient (e.g. physiological parameters or phenotypic traits), preferably including features that might be measured in real subjects. For example, and as represented in FIG. 4, each of several virtual patients can be defined by specifying various combinations of features of the muscle system, adipose tissue, liver function, and pancreatic function, each of which are represented in a computer model of the virtual patient. A computer simulation can be used, for example, to produce virtual measures of certain biological features such as blood sugar and insulin, given such underlying features. Typically, a virtual patient will be represented by virtual measures that include both values provided as input to a mathematical model of a biological system and values produced by the computer model.

Methods for defining virtual patients are described in more detail in co-pending and commonly owned U.S. patent application Ser. No. 10/961,523 entitled “Simulating Patient-Specific Outcomes,” which is herein incorporated by reference in its entirety. In brief, a model is defined to simulate one or more biological processes or systems. The simulation model typically includes a set of parameters that affect the behavior of the variables included in the model. The parameters can be used to define a patient, aspects of the processes, or other features of the simulation. For example, the parameters represent initial values of variables, half-lives of variables, rate constants, conversion ratios, and exponents. The variables typically admit a range of values, due to variability in experimental systems, and can change over the course of the simulation. Input values of certain variables can be set prior to performance of a simulation operation. Output values for these or other variables can then be observed at the conclusion of a simulation operation.

The simulation model is typically a computer model and can be built using a “top-down” approach that begins by defining a general set of behaviors indicative of a biological condition, e.g. a disease. The behaviors are then used as constraints on the system and a set of nested subsystems are developed to define the next level of underlying detail. For example, given a behavior such as cartilage degradation in rheumatoid arthritis, the specific mechanisms inducing the behavior are each modeled in turn, yielding a set of subsystems, which can themselves be deconstructed and modeled in detail. The control and context of these subsystems is, therefore, already the behaviors that characterize the dynamics of the system as a whole. The deconstruction process continues modeling more and more biology, from the top down, until there is enough detail to replicate a given biological behavior. Specifically, the model is capable of modeling biological processes that can be manipulated by a drug or other therapeutic agent.

In some instances, the computer model can define a mathematical model that represents a set of biological processes of a physiological system using a set of mathematical relations. For example, the computer model can represent a first biological process using a first mathematical relation and a second biological process using a second mathematical relation. A mathematical relation typically includes one or more variables whose behavior (e.g., change over time) can be simulated by the computer model. More particularly, mathematical relations of the computer model can define interactions among variables, where the variables can represent levels or activities of various biological constituents of the physiological system as well as levels or activities of combinations or aggregate representations of the various biological constituents. In addition, variables can represent various stimuli that can be applied to the physiological system.

Exemplary models of biological systems that can be used to produce virtual measures for virtual patients include systems described in co-pending U.S. patent applications bearing publication Nos. 2003/0014232, 2003/0058245, 2003/0078759, and 2003/0104475.

Running the computer model produces one or more sets of outputs for a biological system represented by the computer model. One or more of the sets of outputs represent one or more biological states of the biological system, and includes values or other indicia associated with variables and parameters at a particular time and for a particular execution scenario. The computer model can represent a normal state as well as a disease state of a biological system. For example, the computer model includes parameters that are altered to simulate a disease state or a progression towards the disease state. The parameter changes to represent a disease state are typically modifications of the underlying biological processes involved in. a disease state, for example, to represent the genetic or environmental effects of the disease on the underlying physiology. By selecting and altering one or more parameters, a user modifies a normal state and induces a disease state of interest. In one implementation, selecting or altering one or more parameters is performed automatically.

Various virtual patients are associated with different representations of a biological system. In particular, various virtual patients of the computer model represent, for example, different variations of the biological system having different intrinsic characteristics, different external characteristics, or both. A virtual patient in the computer model can be associated with a particular set of values for the parameters of the computer model. Thus, virtual patient A may include a first set of parameter values, and virtual patient B may include a second set of parameter values that differs in some fashion from the first set of parameter values. For instance, the second set of parameter values may include at least one parameter value differing from a corresponding parameter value included in the first set of parameter values. In a similar manner, virtual patient C may be associated with a third set of parameter values that differs in some fashion from the first and second set of parameter values.

An observable condition (e.g., an outward manifestation) of a biological system is referred to as its phenotype, while underlying conditions of the biological system that give rise to the phenotype can be based on genetic factors, environmental factors, or both. Phenotypes of a biological system are defined with varying degrees of specificity. In some instances, a phenotype includes an outward manifestation associated with a disease state. A particular phenotype typically is reproduced by different underlying conditions (e.g., different combinations of genetic and environmental factors). For example, two human patients may appear to be similarly arthritic, but one can be arthritic because of genetic susceptibility, while the other can be arthritic because of diet and lifestyle choices.

One or more virtual patients can be created using the computer model based on an initial virtual patient that is associated with initial parameter values. A different virtual patient can be created based on the initial virtual patient by introducing a modification to the initial virtual patient, for example, as described in the co-pending and commonly owned U.S. patent application Ser. No. 10/961,523. Such modification can include, for example, a parametric change (e.g., altering or specifying one or more initial parameter values), altering or specifying behavior of one or more variables, altering or specifying one or more functions representing interactions among variables, or a combination thereof.

One or more virtual patients in the computer model can be validated with respect to the biological system represented by the computer model as described in more detail in co-pending and commonly owned U.S. patent application Ser. No. 10/961,523. Validation typically refers to a process of establishing a certain level of confidence that the computer model will behave as expected when compared to actual, predicted, or desired data for the biological system. For certain applications, various virtual patients of the computer model can be validated with respect to one or more phenotypes of the biological system. For instance, virtual patient A can be validated with respect to a first phenotype of the biological system, and virtual patient B can be validated with respect to the first phenotype or a second phenotype of the biological system that differs in some fashion from the first phenotype.

E. Virtual Patient Populations

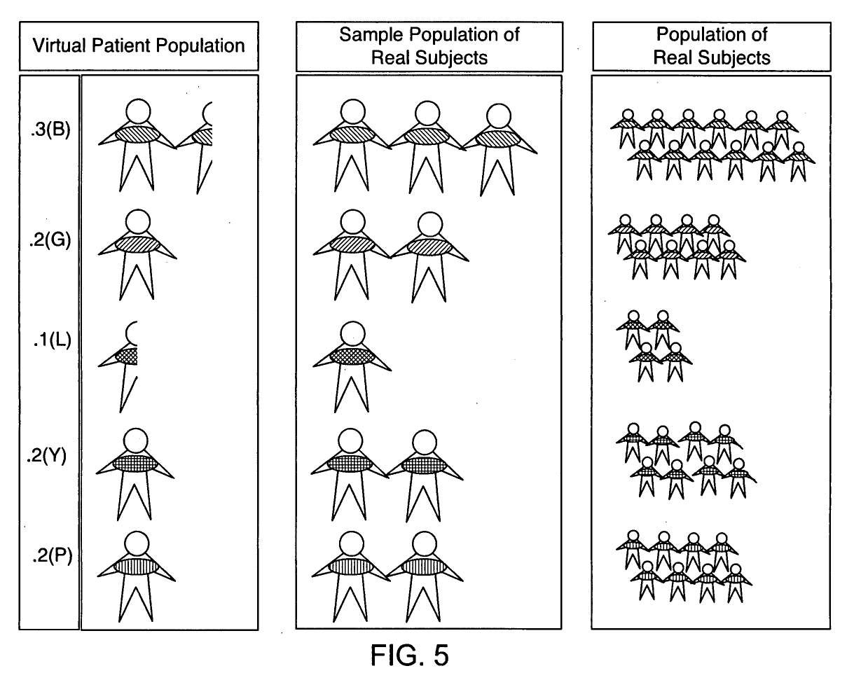

The collection of virtual patients is ideally representative of the population, as shown in FIG. 5. If the sample population of real subjects is representative of the population (as shown by the similar frequency of each of five phenotypes), then the collection of virtual patients should be similar to the sample of real subjects from the population. For example, as shown in FIG. 5, a collection of virtual patients has virtual patients that approximate the phenotypes observed in the sample population (as indicated by the color of the ellipse on the patient's or subject's chest). In addition, the weighted frequency of each virtual patient in the virtual patient population is similar to the frequency of the corresponding real subject in the sample and, in this case, in the clinical population.

A virtual patient population is typically intended to be representative of the population with respect to at least some features of the population. Whether the virtual patient population is representative of the population is typically indicated by some evaluation of similarity, for example, by comparing the distribution of values or summary statistics for that feature in the virtual patient population and the population.

A collection of virtual patients that is representative of the population typically includes virtual patients that are representative of real subjects. For example, the collection of virtual patients may include, for example, both the basic clinical presentations of those real subjects and conditions of the real subjects that may contribute to or account for the clinical presentation. The underlying conditions ideally include features that may have different underlying mechanisms. For example, in a study of diabetes and obesity, the virtual patients may be characterized by features including obesity and insulin sensitivity, with specific virtual patients having various combinations of virtual measures including for example, insulin insensitive to mild diabetic to severe diabetic, and normal to overweight to obese. A subject may be obese, for example, because of genetic predispositions (e.g., Pima Indians) or because. of lifestyle choices (e.g., high fat diet, no exercise). Accordingly, the pool of virtual patients may include virtual patients representing subjects with a predisposition to obesity and virtual patients representing subjects who are obese due to lifestyle choices.

A collection of virtual patients is representative of the population when statistics describing the virtual patients are similar to the same statistics describing the real subjects in the population. For example, the mean and variance of one or more population characteristics of the virtual patients is preferably similar to the mean and variance of the same one or more population characteristics in the sample population of real subjects. Also for example, where each of several virtual patients is comparable to a collection of real subjects, the frequency of each virtual patient in a virtual patient population is preferably similar to the frequency of each of the corresponding sets of real subjects in the population.

Analysis of a virtual patient population can provide insight on the population of real subjects. Virtual patients can be used, for example, to predict the particular consequences for an individual of a protocol for treatment of a disease. A virtual patient population, on the other hand, can be used to assess population-wide attributes associated with the virtual measures of the virtual patients. For example, a virtual patient population can be used to predict the population-wide impact of an intervention. In general, analysis of a virtual patient population permits informed inferences or predictions about a population of real subjects.

Virtual measures for a collection of virtual patients can be analyzed in any of numerous ways known to those of skill in the art. Results of two or more virtual measures can, for example, be determined to be substantially correlated with the occurrence of another measure based on one or more standard statistical tests. Statistical tests that can be used to identify correlation can include, for example, linear regression analysis, nonlinear regression analysis, and rank correlation. In accordance with a particular statistical test, a correlation coefficient, such as Pearson's Product Moment Correlation Coefficient and the Spearman Rank Correlation Coefficient, can be determined, and correlation can be identified based on determining that the correlation coefficient falls within a particular range.

For example, two or more virtual measures for a collection of virtual patients can be analyzed to identify potential biomarkers indicative of a disease state. A biomarker can refer to a biological attribute or combination of attributes that can be used to infer or predict a particular process, result, or state, such as a disease state, as described in more detail in co-pending and commonly owned U.S. patent application Ser. No. 10/961,523. Measures or combinations of measures that indicate a state of interest, for example, a disease state reflected by another measure, can be identified, for example, by assessing their correlation.

The identification of correlations among virtual measures can also be used in combination with manipulations of model parameters. Such manipulations can be used to identify potential new interventions, e.g. use of an antagonistic drug, or to explore the relative efficacy of a variety of therapeutic regimens for the virtual patient population. For example, a change in the value of the binding constant for a particular reaction can represent the potential effect of a new drug. The model can be used to simulate the effect of the drug on each particular virtual patient and the virtual patient population.

Observations based upon analysis of the individual virtual patients, such as correlations, can reflect relationships in a population of real subjects when the collection of virtual patients is representative of the population of real subjects. In general, the use of a correlation or other observation of the virtual patients to interpret or predict behaviors in the population of real subjects is generally most appropriate when the prevalence of various virtual patients in the virtual patient population is similar to or representative of the prevalence of analogous real subjects in the population. If some virtual patients are over-represented in the virtual patient population compared to the population of real subjects, those virtual patients will make a disproportionately large contribution to the observed correlation; whereas if some virtual patients are under-represented in the virtual patient population compared to the population of real subjects, those virtual patients will make a disproportionately small contribution to the observed correlation. When virtual patients over- or under-represent real subjects in a population, conclusions based upon the analysis of the virtual patients may not apply to the population of real subjects.

The definition of a virtual patient population as a collection of virtual patients, each of which is weighted according to the frequency of occurrence of similar real subjects in a sample population, allows conclusions based upon analysis of the virtual patients to be more appropriately extended to the population of real subjects. That is, when the virtual patient population resembles the sample population, and preferably the population represented by the sample population, the virtual measures for the virtual patients can be used to explore and extend our understanding of the population of real subjects.

Virtual patient populations can be used in research and development; clinical data management; clinical trial design and management; target, diagnostic, and compound analysis; bioassay design; ADMET (absorption, distribution, metabolism, excretion, and toxicity) analysis; and biomarker identification. The analysis of virtual patient populations may provide insight into the prevalence of patient types in the population, improve our ability to predict the outcomes of a clinical trial, and generally help bridge information and insights from in silico mechanistic studies with whole organism research on real subjects, including clinical and epidemiological studies.

F. Types of Data or Virtual Measures

To define a virtual patient population, virtual measures of the virtual patients are compared to data representing real subjects from a population. The methods that are used to evaluate the similarity of the virtual patients to the real subjects vary depending upon the type of data and virtual measures that are used.

Data for real subjects in a sample population and virtual measures for each of two or more virtual patients can, for example, represent independent or dependent variables. Independent variables describe features whose values are typically set or known for a particular individual; whereas dependent variables describe features whose values causally depend, whether actually or hypothetically, upon the values of the independent variables. Data or measures for independent variables can represent the demographics and physiologic state variables of the population and related subpopulations. For example, independent variables can describe features such as blocking factors (e.g. gender, ages, disease state, body weight, body mass index), initial physiological measures (e.g. “initial HbAlc”), and patient class predictors (e.g. HER-2 positive women for Herceptin in breast cancer). The values of the dependent variables typically characterize the state of a particular virtual patient or real subject, and can be used to answer a question about a possible relationship with the independent variables. Data or measures of dependent variables represent, for example, physiological features that depend on environmental or genetic features, or the result of the intervention (e.g., drug therapy). The designation of variables as independent or dependent may represent a hypothesized causal relationship between the variables that is not supported by the relationship between the variables for a particular collection of real subjects or virtual patients.

The data obtained for real subjects and the virtual measures acquired for virtual patients can be univariate, e.g. including a single datum representing a single variable for each real subject or virtual patient. Alternatively, the data for real subjects and the virtual measures for virtual patients can be multivariate, e.g. including values for multiple variables as a vector for each real subject or virtual patient.

The data for real subjects and the virtual measures for virtual patients can be categorical. Categorical variables are assigned values according to their attributes (nominal variables) or ranked according to their magnitude (ordinal variables). For example, gender and the presence or absence of a disease state are categorical variables. Categorical variables can be used, for example, to identify subpopulations. Categorical variables can be appropriately analyzed using any of various and known non-parametric methods of statistics.

The data for real subjects and the virtual measures for virtual patients can be continuous or discontinuous. Continuous variables can, in theory, assume an infinite number of values between any two fixed points. For example, weight is a continuous variable because there are an infinite number of exact measurements between any two measures. Discontinuous variables, also known as meristic or discrete variables, are ordered but have only certain fixed numerical values, with no intermediate values possible in between. For example, the number of occurrences of an event is a discontinuous variable because fractional occurrences are not possible. Continuous variables and in some cases discontinuous variables can be appropriately analyzed using any of various and known parametric methods of statistics. Parametric statistics are preferably used when certain assumptions, e.g. normality of the distributions and random sampling, are satisfied.

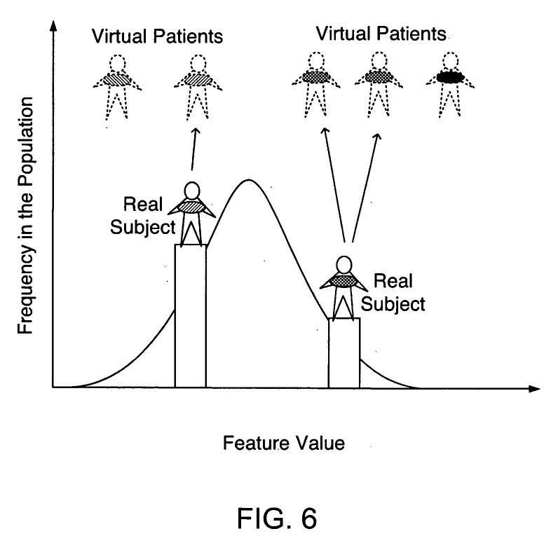

The data obtained for real subjects and the virtual measures for virtual patients can be static or dynamic. Static data or measures typically represent cross-sectional variability. Cross-sectional studies sample variability across subjects or patients and may approximate or be represented by well-defined parametric distributions, e.g., the normal Gaussian curve, as shown in FIG. 6. Such variability can occur causally due for example to differences among subject or patients in underlying biological factors and typically also includes a component attributable to random variability and measurement error. Errors in sampling of a population may result in deviations between, for example, the variability observed for the sample population and the true variability in the population. Variability in features from subject to subject, or from patient to patient, can be characterized, for example, by a measure of the standard deviation or variance.

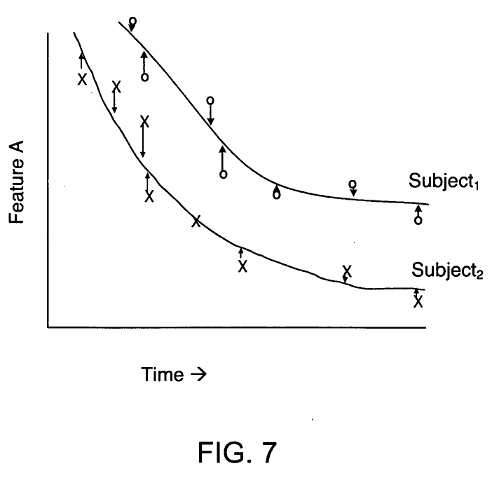

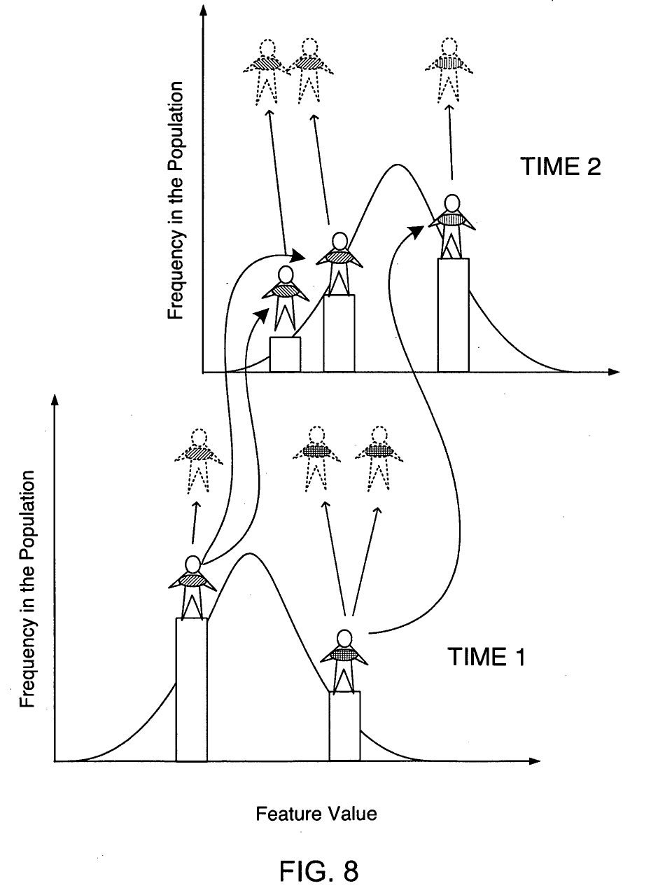

Dynamic data or measures typically represent longitudinal (e.g. temporal) variability. Longitudinal studies sample variability within a subject or patient, typically over simulated or actual time. Such variability can occur causally due for example to the dynamics of the biology, and typically also includes a component attributable to random fluctuations within the patient and measurement error, as shown in FIG. 7. A collection of real subjects or virtual patients can be characterized by both cross-sectional and longitudinal variability, as shown in FIG. 8. Longitudinal variability can be sampled, for example, by optimal sampling schemes, e.g. D-, O-, C-optimal designs, to estimate the appropriate variance-covariance matrices from the data. These designs depend explicitly on a well defined characterization of the dynamic trajectory.

To evaluate the similarity of the virtual patients to the real subjects, it may be useful to account for variability in the features of the virtual patients and the real subjects. For example, cross-sectional data can be used to estimate variability among features of interest of virtual patients or real subjects and longitudinal data can be used to estimate within-patient and within-subject variability in features of interest, including for example the shape or dynamics of a temporal trajectory. Features of interest include those that can be characterized by dependent variables and independent variables. Independent variables that may account for variability in the dependent variables can be identified and used to reduce confounding variability in the dependent variables and permit the identification of causal relationships of interest. For example, categorical variables such as gender, age group, and disease group; and continuous variables such as genetic susceptibility, age, and disease indicator can be used to help account for variability in the dependent variables.

Based upon the similarity between the features of the real subjects and the virtual patients, the prevalence of each virtual patient in a virtual patient population can be adjusted. For example, if the real subjects in the sample population fall primarily into one age or disease category, the prevalence of virtual patients in that age or disease category can be adjusted to approximate the prevalence observed in the sample population. In general, the prevalence of each of the virtual patients is adjusted by assigning a weight, or prevalence, to each virtual patient based on the evaluation of similarity. The assignment is typically intended to improve the similarity between certain features of the virtual patients and the real subjects.

For example, for univariate cross-sectional data and measures of a dependent variable, similarity between the features of the real subjects and the virtual patients can be evaluated by comparing the mean value of the feature for the real subjects with the mean value of the feature for the virtual patient population. Alternatively or in addition, similarity between the features of the real subjects and the virtual patients can be evaluated by comparing the mode, standard deviation, variance, skewness, or kurtosis of the feature for the real subjects with the mode, standard deviation, variance, skewness, or kurtosis, respectively, of the feature for the virtual patients. When only summary statistics are available for the real subjects, information on additional variables will typically be necessary to assign prevalences to the virtual patients. For example, if there are data and measures for one or more independent variables, the mean, mode, standard deviation, variance, skewness, or kurtosis of the feature for the real subjects can be calculated for each value of the independent variable. The representation of virtual patients in the virtual patient population can then be adjusted so that statistics for the virtual patients having each value of the independent variable are similar to the statistics for the real subjects.

For longitudinal data and measures of a single dependent variable, and if only population-wide summary data is available for the real subjects, it is at least possible to identify the shape and character of a (mean) trajectory. The representation of virtual patients in a virtual patient population can be adjusted so that their trajectories are representative (e.g. have a similar mean trajectory, similar shaped trajectories, etc.) of the mean trajectory of the real subjects.

When data are available for one or more features of each of the real subjects, the values for the one or more features of each real subject can be compared to the values for the virtual patients. The prevalence of virtual patients can then be adjusted so that the distribution of values for the virtual patients more closely resembles the distribution of values for the real subjects. For example, if the distributions are assumed to be Gaussian normal, various parametric statistics can be used to characterize the distribution of values for the real subjects and the distribution for the virtual patients. For example, an estimate of the mean and standard deviation of values of a feature for the real subjects can be used to determine a probability of observing a particular value of the feature as for a virtual patient. Prevalence for a virtual patient can be determined as a function of that probability.

The prevalence of virtual patients can then be adjusted so that those similar statistics for the virtual patients taken according to their prevalenceing, more closely approximate the statistics for the real subjects.

Similarly, for univariate longitudinal data, when data are available for each of the real subjects, the values for the one or more features of each real subject can be compared to the values for the virtual patients. The individual trajectories for each real subject and the variations observed across them can be estimated. The virtual patients having trajectories similar to the trajectories of one or more real subjects can then be weighted to produce similar measure of population-level variability. If there are data and measures for independent variables, we can identify and account for confounders (i.e., subpopulations and covariates) that affect the variance around the trajectory and the trajectory-to-trajectory variance, as discussed previously.

Virtual patients can be identified prospectively, such that virtual measures are acquired only for those virtual patients that represent one or more real subjects in population. Alternatively, virtual measures can be acquired for a variety of virtual patients and one or more of the virtual patients, for example virtual patients that do not represent features of real subjects, can be assigned a zero weighting. The values of features of virtual patients that are weighted as zero will not be included in statistics calculated for the virtual patient population; that is, a weighting of zero has the effect of removing the virtual patient from the virtual patient population.

For multivariate data and measures of a dependent variable, similarity between the features of the real subjects and the virtual patients can be evaluated by comparing the mean values of the features for the real subjects with the mean values of the features for the virtual patients, as discussed above for univariate data. For example, a vector containing mean % body fat and mean fasting insulin levels of the real subjects can be compare to a vector containing mean % body fat and mean fasting insulin levels of the virtual patients. If there are data and measures for independent variables, additional independent variables can be used to account for variability (e.g. due to subpopulation or covariates) and adjust the prevalences of virtual patients.

When multivariate cross-sectional data are available for the features of each of the real subjects, the values for the features of each real subject, or preferably statistics based upon them, can be compared to the similar values or statistics for the virtual patients. For example, the features of the real subjects in the sample population and the virtual patients can each be characterized by a covariance matrix. The covariance matrices can then be compared, for example, by qualitatively evaluating the similarity in magnitude of corresponding matrix elements. Also for example, methods for the analysis of univariate data and measures can be extended to include multiple variables. For example, a vector of estimates of the mean and standard deviation of values of the features for the real subjects can be used to determine a probability of observing a particular set of values of the features for a virtual patient. Prevalence for a virtual patient can be determined as a function of that probability

Similarly, for multivariate longitudinal data, when data are available for each of the real subjects, the values for the features of each real subject can be compared to the values for the virtual patient. The individual trajectories for each real subject and the variations observed across them can be estimated. The virtual patients having trajectories similar to the trajectories of one or more real subjects can then be weighted to produce similar measures of population-level variability. That is, it is possible to estimate the dynamics of the individual multivariate mean and each individual variance-covariance matrix, S. Assuming the data are sufficient to estimate each individual's S from the data, we can estimate the population-wide variance-covariance matix, Σ, and if we assume multivariate normality, we can measure a statistical distance and determine the probability of observing a real subject having values as for a particular virtual patient.

Using similar techniques, it is possible to identify values of features of real subjects that are not well-represented among the virtual patients. For example, if all virtual patients are statistically far from the observed mean, a new virtual patient can be built that has feature values that are closer to the mean of the observed values.

The set of data and measures that are used to determine prevalence weighting of virtual patients can be the same as or different from measures that are used to analyze relationships among variables for the virtual patients and/or real subjects. Typically, the data used to assign prevalences to virtual patients are the same data that are used to make predictions, for example, about the relationships between independent and dependent variables. Alternatively, one set of common features can be used to evaluate the similarity of virtual patients and real subjects and to assign prevalences to the virtual patients, and a different set of common features can be used to evaluate relationships between the independent and dependent variables within the sample population or the virtual patient population.

G. Examples

The following examples are provided to illustrate embodiments of the invention as described herein and are not intended to limit the scope of the invention in any way. For each example, a project goal is defined, the source of the data for the real subjects is provided, the nature of the data is described, the source of the virtual measures for the virtual patients is provided, and the methodology for evaluating similarity and assigning prevalences is discussed.

1. Differentiation of Hematology Interventions

The goal of this project was to determine optimal dosing strategies for differentiation between two different drugs used to treat anemia. Data for real subjects were obtained from outcomes of extant clinical studies for the two drugs. The data for the real subjects included longitudinal multivariate data describing patient response to therapy, dosing protocols, and patient demographics. The dependent variables of interest included RBC, hematocrit, and reticulocyte counts. Virtual measures for virtual patients were acquired from an Entelos® PhysioLab® system; similar mechanistic models are described in co-pending U.S. patent applications bearing publication Nos. 2003/0014232, 2003/0058245, 2003/0078759, and 2003/0104475.

The data for the real subjects and the virtual measures for the virtual patients were first readied for analysis. A standard set of measures was defined for use in characterizing features of the patients such as patient types and responses. This standard set of measures was definable by data available for the real subjects and corresponding virtual measures that could be made available for the virtual patients. The standard set of measures was calculated for each real subject using the data obtained. Summary statistics and histograms were generated to understand the distribution of values for each feature in the standard set.

The virtual measures needed to define the standard set of measures for a collection of virtual patients were generated with a mechanistic computer model. The virtual patients were defined to be consistent with all data and behavioral constraints available for the real subjects in the sample population. For example, certain values for the virtual patients were chosen to be representative of the biological variability known or hypothesized to give rise to the observed variability in features of the real subjects. The virtual measures, including both variables and parameters of each virtual patient defined as input to the model and variables defined by the output of the model, were used to calculate the standard set of measures for the virtual patients.

The parameters of the clinical trial involving the real subjects were used to help define variables and parameters for the virtual patients. Thus, the simulation of virtual patients represented a simulation of the clinical trial.

The standard set of measures for the real subjects and for the virtual patients were analyzed to evaluate their similarity. A check was made to assess whether, for each measure in the standard set, the values of the virtual patients covered the range of values observed for the real subjects. To the extent that there were gaps in the coverage, additional virtual patients were built to fill the gaps. Additional virtual patients were built by duplicating existing virtual patients and changing the values of variables used as input to the model and/or fine-tuning parameters that might affect biological uncertainties in the mode, and then generating output for those virtual patients from the model. Additional virtual patients can be built by creating one or more new virtual patients having values of variables used as input to the model and/or parameters that are different than those for previously created virtual patients and generating output from the model.

Prevalence scores were assigned according to the following matching algorithm. Each real subject or virtual patient is characterized by a vector of measures describing the features of interest, i.e. the patient and the patient's response to the clinical trial protocol. In general, for a number of real subjects, N; a number of virtual patients, V; and a number of measurements in the standard set, M; there is an N×M matrix of measures for real subjects and a V×M matrix of virtual measurements. To match real subjects and virtual patients according to the similarity of their features, each virtual patient is awarded a matching score for every real subject that it matched using the following algorithm.

For each measure in the standard set, the mean and standard deviation is computed for the real subjects and used to normalize each value of the measure for the real subjects and the virtual patients. Each value of a measure is normalized by subtracting the mean for the real subjects and dividing by the standard deviation for the real subjects. The measures are weighted according to their importance. Then, for each possible virtual patient—real subject pair, the distance between the weighted normalized measures of the virtual patient and the normalized measures of the real subject are computed. For example, if each measurement mᵢ has weight wᵢ, then the distance between the standard set of measures of Virtual Patient 1 (VP1) and Real Subject 1 (RP1) is

$${\sum }_{i = 1}^{M} {( {w}_{i}^{*} VP 1 {m}_{i} - {w}_{i} * RP 1 {m}_{i} )}^{2} .$$

A match threshold, t, is set. A virtual patient is awarded a matching score if the distance is below the threshold t. The smaller the distance, the better the match and the higher the score. (The measurement weights wᵢ and the threshold t can be adjusted to give a better fitting or more inclusive set of matching scores.)

For each real subject, the matching scores awarded to the matching virtual patients are normalized so that they sum to 1 (by dividing each of them by the sum of all). Then, for each virtual patient, a total score is determined as the sum of its normalized matching scores. Finally, the total scores of the virtual patients are normalized across the entire virtual patient population so that they sum to 1 (by dividing each of them by the sum of all). The normalized total score of each virtual patient is the virtual patient's prevalence assignment.

A virtual patient population was defined as the virtual patients according to their respective prevalence weights, which were determined using the previous algorithm. To ascertain whether the prevalences were appropriate or useful, the summary statistics for the virtual patient population were compared to summary statistics for the sample population. Means and standard deviations for the virtual patient population were calculated according to the following equations.

For each standard measure, means and standard deviations for the virtual patients are calculated according to their prevalence weights. In calculating summary statistics for the sample population, equal weight is given to each patient; for the virtual patient population, each virtual patient's contribution to the summary statistic is weighted by the virtual patient's prevalence score. For example, for a standard measure mᵢ, a mean μᵢ is defined as a function of V virtual patients, VPⱼ, where j={1, 2, . . . V), having prevalence weights, prevⱼ, where j={1, 2, . . . V), as follows:

$${μ}_{i} = {\sum }_{j = 1}^{V} ( {VP}_{j} {m}_{i} * {prev}_{j} )$$

Similarly, for a standard measure mᵢ, a standard deviation σ²ᵢ is defined as a function of V virtual patients, VPⱼ, where j={1, 2, . . . V), having prevalence weights, prevⱼ, where j={1, 2, . . . V), as follows:

$${σ}_{i} = \sqrt{{\sum }_{j = 1}^{V} {VP}_{j} {m}_{i}^{2} * {prev}_{j} - {( \sum {VP}_{j} {m}_{i} * {prev}_{j} )}^{2}}$$

The means and standard deviations of the prevalence weighted measures for the virtual patient population were compared to the means and standard deviations of the real subjects. Means and standard deviations were compared qualitatively; individual means could also be compared quantitatively, for example, using a standard t-test. If the match is not satisfactory, the prevalence assignment can be changed by adjusting measurement weights and/or the threshold value used in the prevalence assignment algorithm; the process of assigning prevalence weights and evaluating the similarity between a virtual patient population and the real subjects can be repeated until a suitably similar virtual patient population is identified.

A further evaluation of the measures of the virtual patient population and the real subjects can be made by creating histograms of the measure for the virtual patient population and real subjects. To generate a histogram for a measure, the range of values is discretized. A histogram for the real subjects is created by counting the number of real subjects whose values for that measure fall into each discrete range, and plotting the counts as a function, for example, of the mean value of the measure. A histogram for the virtual patient population is created by summing the prevalences of virtual patients whose values for that measure fall into each discrete range, and plotting the sums as a function, for example, of the mean value of the measure.

There was good similarity between the measures for the sample population and the virtual patient population. Both simple statistics and distributions for the clinical simulation of the virtual patient population resembled the statistics and distributions for the real subject population. The virtual patient population was therefore deemed suitable for use in prospective simulations of possible future clinical trials.

2. Biomarkers for Insulin Sensitivity

The goal of this project was to identify an optimal set of simple, non-invasive, single-point diagnostic tests to serve as a biomarker for assessing insulin sensitivity. Data for real subjects were obtained from publications including values for two standard derived measures of association, HOMA and QUICKI, between insulin resistance and fasting plasma glucose and insulin levels. The data for the real subjects included cross-sectional bivariate correlation data derived from Glucose Infusion Rates (GIRs) observed under clamp conditions (both hyperinsulinemic-euglycemic and hyperinsulinemic-isoglycemic clamps). Virtual measures for virtual patients were acquired from an Entelos® PhysioLab® system; a similar mechanistic model is described in co-pending U.S. patent application bearing publication No. 2003/0058245

Data were acquired for 93 virtual patients. The 62 virtual patients who established stable GIRs within the allotted experiment window, i.e., those virtual patients who passed the simulated acceptance criteria for entry into an in silico trial, were used in the following analyses. Methods for acquiring data for the virtual patients are described in more detail in co-pending and commonly owned U.S. Patent Application Ser. No. 60/637,309 entitled “Assessing Insulin Resistance Using Biomarkers,” which is herein incorporated by reference in its entirety.

The virtual patients and the real subjects were both characterized by measures of insulin resistance and fasting plasma glucose and insulin levels, for hyperinsulinemic-euglycemic and hyperinsulinemic-isoglycemic clamps. These measures were used to calculate QUICKI values and SI_{Clamp} insulin sensitivity measures.

To evaluate the similarity of the common features of the real subjects and the virtual patients and assign prevalence weights, it was assumed that there was a linear correlation between the derived QUICKI values and the derived measures of insulin sensitivity from the SI_{Clamp} for the virtual patients, as had been observed for the real subjects. It was also assumed that virtual patients were normally distributed about the linear regression line. Thus, it was possible to infer the weighted least squares fit to the data and the appropriate weightings simultaneously.

Mathematically, the relationship could be represented as

$${y}_{i}^{′} = {mx}_{i} + b$$

$${w}_{i} = \frac{1}{C} exp [ \frac{{( {y}_{i} - {y}_{i}^{′} )}^{2}}{2 {σ}^{2}} ]$$

where xᵢ are the simulated values for QUICKI, yᵢ are the simulated values for SI_{Clamp}, y′ᵢ represents the linear functional values of QUICKI that best approximate the simulated values for SI_{Clamp}, σ² is the standard deviation, and wᵢ is the prevalence of the virtual patient i in the virtual patient population. C is a normalization constant for the weights.

Thus posed, the problem was under-constrained. A penalty term was therefore added to the sum of weighted squared errors; the penalty term increases with the departure of the weightings from a uniform distribution and is a penalty for deviation from uniformity. The objective function, J, to be minimized to solve for the parameters was

$$J = \sum {{w}_{i} ( {y}_{i} - {y}^{′} )}^{2} = α \sum {( {w}_{i} - \frac{1}{N} )}^{2}$$

where N is the number of virtual patients and y′ᵢ and w′ᵢ are as defined above.

Using the data for the virtual patients, the equation was solved for m, b, and α by minimizing J. The penalty was approximately equal to the sum of squared errors and yielded a line with a slope similar to that of the data reported in the literature and an R² of 48%. However, the slope of the line was not within the 99% confidence interval of the line through data from Katz, A., Nambi, S. S., Mather, K., Baron, A. D., Follmann, D. A., Sullivan, G., and Quon, M. J. (2000) Quantitative insulin sensitivity check index: a simple, accurate method for assessing insulin sensitivity in humans, J Clin Endocrinol Metab 85, 2402-2410. Thus, without any explicit constraint from the reported data, a weighting function for the simulated virtual patients was found that gave had population statistics similar to those reported for real subjects.

The method was further refined by using a weighting scheme that included a penalty for deviation from the correlation coefficient, r², of the data reported by Katz et al.:

$${J}_{2} = \sum {{w}_{i} ( {y}_{i} - {y}^{′} )}^{2} + α \sum {( {w}_{i} - \frac{1}{N} )}^{2} + {β ( {r}^{′ 2} - {r}_{Katz}^{2} )}^{2}$$

Values of α and β were chosen such that a line through the data for the virtual patients was within the 90% confidence interval of the line through the original clinical regression line.

The robustness of the weighting scheme was tested as follows. In the correlation analysis for the hyperinsulinemic-euglycemic clamp simulations, sensitivity to the weighting scheme was examined by allowing the standard deviation of the hypothesized Gaussian to increase by as much as 100%. Neither the coefficients for the regression analysis nor the goodness of fit was altered when the standard deviation was increased by 50%. When the standard deviation was increased 100%, there was a change in the magnitudes of the coefficients and deterioration in the goodness of fit of the biomarker, but there was no change in the signs of the coefficients or the biological components that provided the optimal fit.

The goodness-of-fit of the two measures was determined by minimizing the weighted coefficient of determination (i.e., the weighted r²), R′² using the prevalence weighted averages as follows:

$$\begin{matrix}{R}^{′ 2} = \frac{{[ \sum {w}_{i} ( {x}_{i} - \overline{x} ) ( {y}_{i} - \overline{y} ) ]}^{2}}{[ \sum {{w}_{i} ( {x}_{i} - \overline{x} )}^{2} ] [ \sum {{w}_{i} ( {y}_{i} - \overline{y} )}^{2} ]} \\ = \frac{\sum {{w}_{i} ( {y}_{i}^{′} - \overline{y} )}^{2}}{\sum {{w}_{i} ( {y}_{i} - \overline{y} )}^{2}} \\ = \frac{{[ \sum {w}_{i} ( {y}_{i}^{′} - {\overline{y}}^{′} ) ( {y}_{i} - \overline{y} ) ]}^{2}}{[ \sum {{w}_{i} ( {y}_{i}^{′} - {\overline{y}}^{′} )}^{2} ] [ \sum {{w}_{i} ( {y}_{i} - \overline{y} )}^{2} ]}\end{matrix}$$

where xᵢ are the simulated values for QUCKI, yᵢ are the simulated values for SI_{Clamp}, y′ᵢ represents the linear functional values of QUICKI that best approximate the simulated values for SI_{Clamp}, and wᵢ is the relative prevalence of the virtual patient in the population, and

$$\overline{x} = \sum {w}_{i} {x}_{i}$$

$$\overline{y} = \sum {w}_{i} {y}_{i} .$$

Accordingly, the weighting scheme defined by wᵢ was assigned to the virtual patients to define a virtual patient population.

3. Characterization of Type 2 Diabetes Patients Using a Clinical Challenge Protocol

The goal of this project was to identify and characterize subpopulations of Type 2 Diabetics and represent them appropriately by selecting extant virtual patients and then building additional virtual patients. Data for real subjects were obtained from a proprietary clinical study involving an Oral Glucose Tolerance Test (OGTT) challenge. The data for the real subjects included multivariate dynamic profile response data describing glucose and insulin levels before and after oral glucose challenge. Virtual measures for virtual patients were acquired from an Entelos® PhysioLab® system; a similar mechanistic model is described in co-pending U.S. patent application bearing publication No. 2003/0058245. Eight virtual patients were used initially; twenty-five additional virtual patients were created to represent biological variation within clusters of real subjects.

The data for the real subjects were analyzed to identify subpopulations. First, data that were derived at fixed times following OGTT challenge were used to characterizing each real subject's dynamic response profile. Real subjects were then clustered into groups. Each group included real subjects having similar dynamic response profiles and the groups spanned the variability in dynamic response profiles observed for the real subjects. The real subjects were grouped using standard clustering algorithms and statistical measures of distance in the multivariate vector space.

The similarity of the virtual patients to the real subjects was evaluated by comparing each of the virtual patients to the average patient in each cluster of real subjects. The average patient for a cluster can be determined, for example, as the center of mass or centroid for the values of the measures of the real subjects in a cluster. A virtual patient was identified as phenotypically similar to an average patient in a cluster by qualitatively comparing the OGTT curves of each virtual patient after a simulated challenge to the OGTT curve of the average real subject. Each of the eight virtual patients was assigned to a cluster, and 80% of the patient population was represented by the eight clusters. The choices were verified by re-clustering the virtual patients along with the original cohort, and verifying that the candidate virtual patients clustered appropriately with the subpopulation they were aimed to represent.

A prevalence weight was assigned to each virtual patient based on the proportion of real subjects observed in the cluster to which the virtual patient was matched. For example, if a virtual patient is assigned to a cluster that holds 25% of the real subjects, that virtual patient was assigned a prevalence weight equivalent to 25% of the sample population.

The resulting virtual patient population was used to explore biological variations that might account for the observed differences in phenotype. For each response feature, underlying features, including for example pathophysiologies and dynamic mechanisms, were identified as possibly accounting for the particular response profiles observed. Virtual patients having features that span that uncertainty space were created and virtual measures including values of their response variables were acquired. The virtual patients were validated to ensure they are reasonable representations of human diabetics. The virtual patients were then challenged with the same OGTT protocol and the set of virtual measures were then used to assign the original virtual patients to phenotypic clusters as described previously. The assignment of a virtual patient to a cluster as expected provided support for the assumptions made in creating the virtual patient. In this way, the impact and robustness of the assumptions leading to the building of the virtual patients could be explored.

4. Characterization of Type 2 Diabetics in the Epidemiological Literature (NHANES III)

The goal of this project was to correlate an existing virtual patient population with a real diabetic population using both anthropomorphic and metabolic phenotypes, and to provide direction for creation of additional virtual patient populations that capture the diversity inherent in a real diabetic population. Data for real subjects were obtained from a publicly available database of the third National Health and Nutrition Examination Survey (NHANES III, conducted from 1988 until 1994). The data for the real subjects included cross-sectional multivariate data, including over 3,600 measured variables in approximately 33,000 individuals, with results for blood testing, body composition, and oral glucose tolerance tests (OGTT) in adults over forty. Virtual measures for virtual patients were acquired from an Entelos® PhysioLab® system; similar mechanistic models are described in co-pending U.S. patent applications bearing publication Nos. 2003/0014232, 2003/0058245, 2003/0078759, and 2003/0104475.

Data obtained from the NHANES Survey Data and virtual measures acquired for 145 virtual patients were compared to identify an appropriate descriptor set of features common to the real subjects and the virtual patients. Measures of blood testing, body composition, and oral glucose tolerance tests (OGTT) in adults over forty were of particular interest. Table 1 shows the thirteen variables that were selected for use in the analysis. These variables existed for both real subjects in the NHANES III database and virtual patients simulated by the computer model. Some of the variables describe the feature of fasting, some describe the feature of OGTT, and some describe the feature of body composition.

TABLE 1
Variables used for both real subjects and virtual patients,
defining features common to the real subjects and the virtual patients.

| Variable | Definition |
|---|---|
| TRP | Serum triglycerides (mg/dL) |
| GHP | Glycated hemoglobin: (%) |
| G1P | Plasma glucose (mg/dL) |
| G1PTIM1 | Minutes between drink and second draw |
| C1P | Serum C-peptide (pmol/mL) |
| I1P | Serum insulin (uU/mL) |
| BMI | Body mass index |
| FFM | Fat free mass - estimated from BIA (lbs) |
| FatM | Fat mass - estimated from BIA (lbs) |
| SMM | Skeletal muscle mass - estimated from BIA (lbs) |
| GlucResp | Incremental glucose response to OGTT (mg/dL) |
| InsResp | Incremental insulin response to OGTT (uU/mL) |
| CPepResp | Incremental C-peptide response to OGTT |
| | (pmol/mL) |

Not all real subjects in the database were included in this study. Rather a sample population of 354 diabetics was identified, using real subjects having self-reported fasting greater than 7.5 hours and a valid OGTT.

The values of each of the thirteen variables for the 354 real subjects and the 145 virtual patients were first characterized by simple statistics including the mean, standard deviation, and range. Each value for each variable was standardized to have a mean of zero and variance of one (by subtracting the mean value of the variable and dividing by its standard deviation). The values for the real subjects and the virtual patients were standardized to the means and variances for the real subjects. Associations between baseline metabolic and anthropometric variables were determined using Spearman correlation analysis.

A principal component analysis (PCA) was performed on data from the real subjects for the 13 variables. The PCA reduced the dimensionality of the descriptor space with an appropriate combination of independent variables accounting for correlations within the independent variable vectors. Reducing the dimension of the space is an essential step in the data analysis as it allows for both a graphical summary of large multivariate data sets and establishes the dependence of the variance on autocorrelated independent variables. The principle components accounting for the largest portions of the variance in the values were selected for further analysis. In particular, the Kaiser criterion (i.e., retain all components with eigenvalues greater than 1) was used to determine the appropriate dimensionality of the reduced space. In this case, the four largest principal components explained 71% of the variance and so the reduction was from thirteen dimensions to four.

A factor analysis with an orthogonal Varimax rotation was then performed to establish a statistical model and 4-dimensional state space describing the relationship among the variables. The factor analysis provide a rotated principal component for each original principal component and a scoring coefficient that is related to the correlation coefficient, R. For example, a value for the serum triglyceride scoring coefficient of 0.551 in PC4 means that 30.4% (100*0.551²) of the variance in serum triglycerides is represented in Principal Component 4.

The factors are shown below in Table 2. A biologically meaningful interpretation was given to each of the principal component-based factors (i.e. factors). Factors 1 and 4 were most heavily influenced by circulating variables; while factors 2 and 3 were most heavily influence by body composition.

TABLE 2
Factors, scoring coefficients, and variances, with variables contributing
most heavily to each factor underlined.

| Variable | Factor1 | Factor2 | Factor3 | Factor4 |
|---|---|---|---|---|
| Serum triglycerides | −0.005 | −0.203 | 0.069 | 0.523 |
| Glycated hemoglobin | 0.270 | 0.028 | −0.061 | 0.091 |
| Fasting Plasma glucose | 0.251 | 0.006 | −0.040 | 0.159 |
| Minutes between drink and | 0.013 | −0.036 | −0.030 | 0.151 |
| second draw | | | | |
| Fasting Serum C-peptide | −0.066 | 0.090 | −0.021 | 0.416 |
| Fasting Serum insulin | −0.077 | 0.145 | −0.015 | 0.338 |
| Body mass index | 0.037 | 0.426 | −0.026 | −0.176 |
| Incremental glucose response to | 0.166 | −0.016 | −0.228 | 0.116 |
| OGTT | | | | |
| Incremental insulin response to | −0.264 | 0.023 | −0.060 | 0.182 |
| OGTT | | | | |
| Incremental C-peptide response to | −0.289 | −0.031 | −0.039 | 0.074 |
| OGTT | | | | |
| Fat free mass | 0.004 | −0.001 | 0.446 | −0.030 |
| Fat mass | 0.049 | 0.469 | −0.098 | −0.237 |
| Skeletal muscle mass | −0.005 | −0.128 | 0.495 | 0.036 |
| % Total variance | 23.8 | 19.4 | 16.2 | 11.8 |
| % Cumulative total variance | 23.8 | 43.2 | 59.4 | 71.1 |

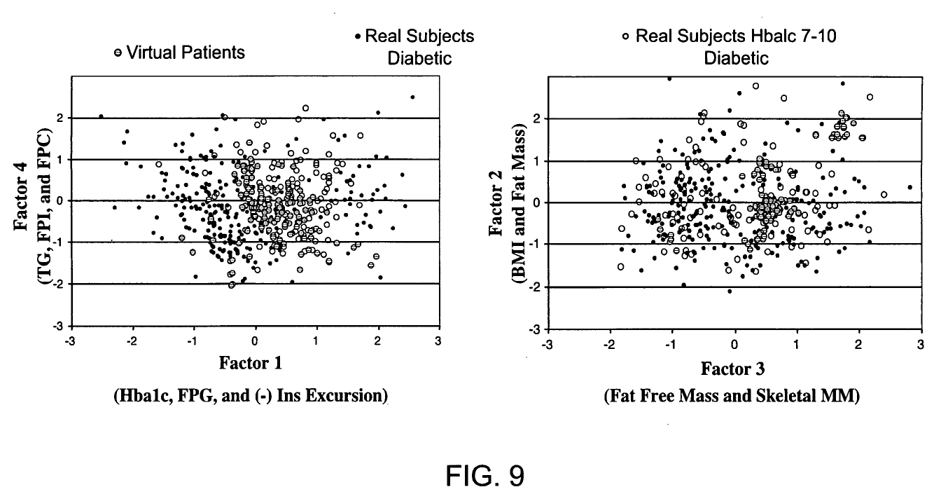

Principal component-based factor values were calculated for each real subject and each virtual patient using these relationships; in other words, the values for each real subject and virtual patient were converted by applying the scoring coefficients and combining them so that they could be expressed and plotted in terms, for example, of pairwise combinations of the newly defined factors, as shown in FIG. 9. The plots revealed that virtual patients tended to score high for factor 3, relating to body mass—probably because they represented males.

The similarity between the converted values for each virtual patient and the converted values for the real subjects was evaluated as follows. First, a genetic optimization algorithm was implemented in MatLab to minimize an objective function that includes the difference between the variance matrices and means of the real subjects and those of the virtual patients. The GA approach used the full covariance-variance matrix to determine weights for the virtual patients. Second, standard statistical approaches were used to identify outliers. A statistical approach can collapse the information to the radial distance in an N-dimensional sphere, but is sensitive to angular dependence in the data. These two approaches were graded by a combination of a goodness-of-fit metrics and out-of-sample testing to additional data for real subjects (described in more detail below).

Third, the statistical distance (e.g. the Mahalanobis distance) from each virtual patient to the centroid of the real population in the reduced 4-dimensional space was calculated. Since the centroid of the real population is the origin (because all Factor variables were standardized to have a mean of zero and standard deviation of one), the Mahalanobis distance Z_{Total} is simply the 4-dimensional Euclidian distance, Z_{Total}=SQRT(Factor₁²+Factor₂²+Factor₃²+Factor₄²), i.e., the radial distance from the origin.

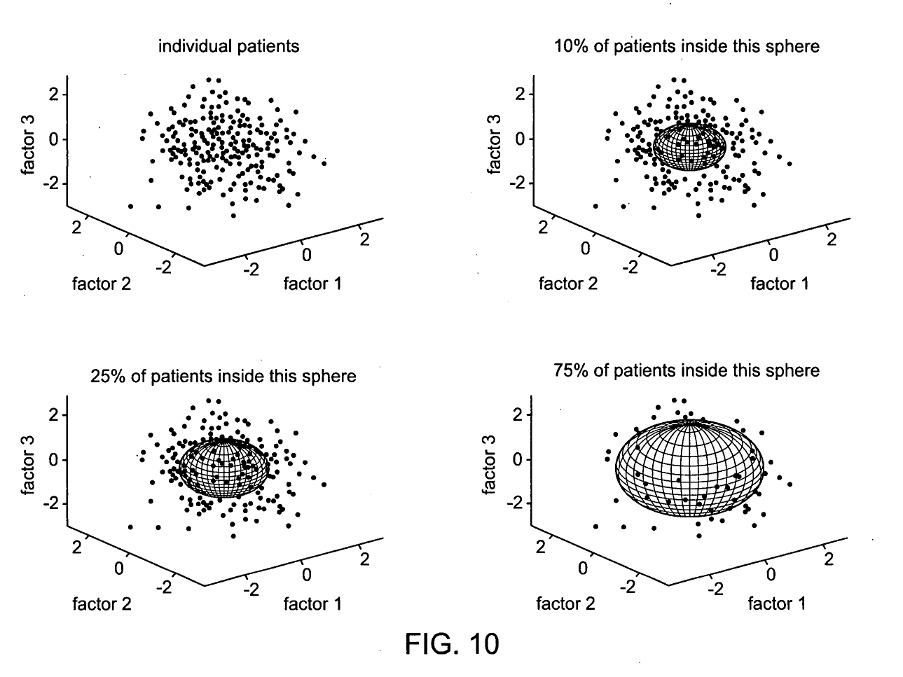

A four-dimensional probability density function (4D-PDF) describing distance from the origin was obtained by assuming that all dimensions are normally distributed. The 4D-PDF is equal to ½*Z_{Total}³*EXP(−Z_{Total}²/2). A sphere centered on the origin could then be defined as encompassing an expected proportion of the population. For example, as shown in FIG. 10, spheres encompassing 10%, 25%, and 75% of the subjects or virtual patients can be defined and shown relative to the actual observations, permitting ready identification of subjects or patients falling outside the probability limit.

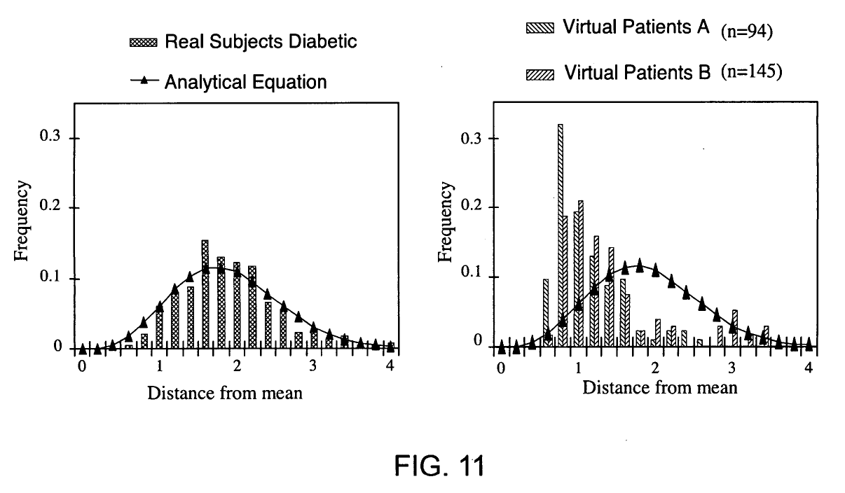

As shown in FIG. 11, the statistical distances were summarized by histograms and empirical probability density functions for the virtual patient populations (VP-PDF) were obtained by interpolating the summary histograms. Statistical distance were also calculated for each of the real subjects and summarized by histograms.

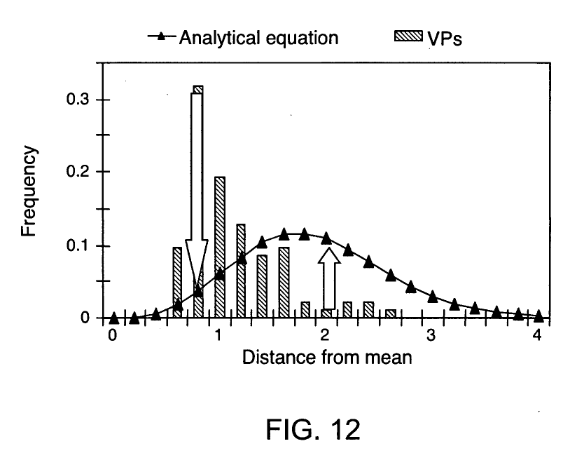

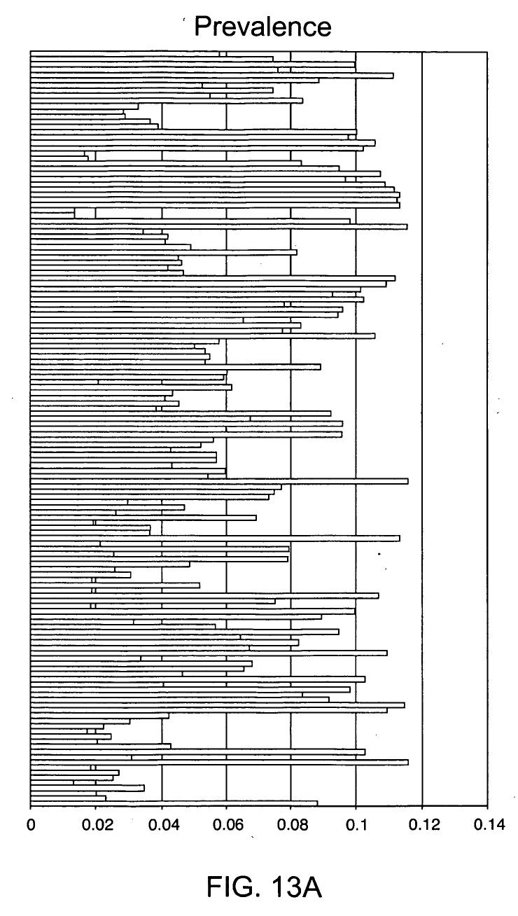

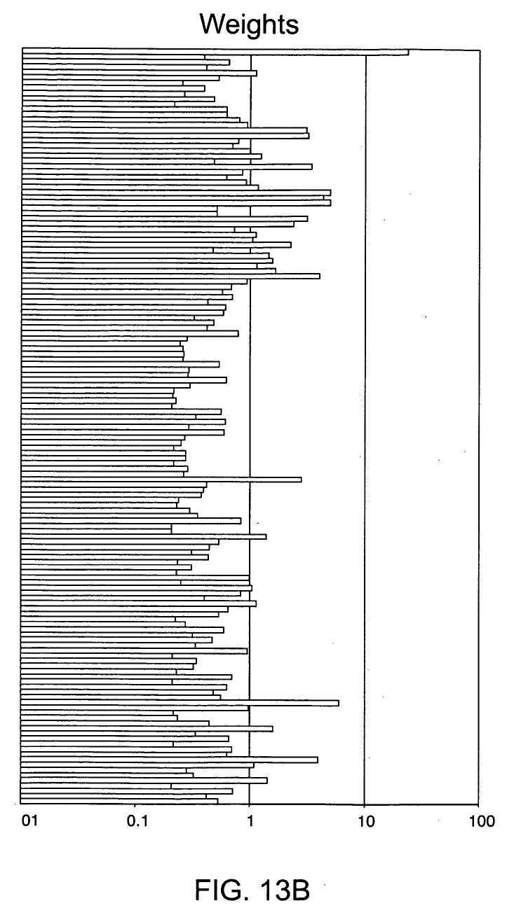

As illustrated in FIGS. 12 and 13, a prevalence weight was assigned to each virtual patient based on its comparison to an individual or group of individuals within the sample population. A probability of each individual virtual patient was obtained by first evaluating the 4D-PDF using the virtual patient's statistical distance from the origin. The prevalence of an individual virtual patient was then determined as the ratio between the 4D-PDF and the VP-PDF. In general, if a virtual patient was overly prevalent, it received a lower weighting and vice versa. FIG. 13 shows the normalized prevalence of each virtual patient compared to the real subjects, and weight applied to each virtual patient.

These methods served to quantify the over-sampling and under-sampling biases of the existing virtual patient population compared to the values of the real subjects. When the VP-PDF is greater than the 4D-PDF, the virtual patient population has over-represented the virtual patient and so it is assigned a prevalence less than one. Conversely when the VP-PDF is less than the 4D-PDF, the virtual patient population has underrepresented a virtual patient and so it is assigned a prevalence greater than one.

The objective criterion for the selection of principal components is to reproduce the population variance as described by the variance of the individual variables. Thus, an appropriate goodness-of-fit metric for the weighting schemes is to quantify the difference between the variance-covariance matrices for values for the virtual patients and the values for the real subjects. This goodness-of-fit metric is represented by

$$Measure = \frac{tr ( ( {\sum }_{VP} - {\sum }_{R} ) {( {\sum }_{VP} - {\sum }_{R} )}^{T} )}{tr ( {\sum }_{R} {\sum }_{R}^{T} )}$$

where Σ_{VP} and Σ_{R} are the variance-covariance matrices of the virtual patient population and the real subjects, respectively.

For the collection of unweighted virtual patients, this goodness-of-fit measure was 0.670, indicating relatively high difference. For the virtual patient population (including virtual patients according to their prevalence weights) and using a statistical approach, this goodness-of-fit measure was 0.485, indicating less of a difference. Thus, the virtual patient population better resembled the sample population than the simple collection of virtual patients.

The invention and all of the functional operations described in this specification can be implemented, in whole or in part, in digital electronic circuitry, or in computer software, firmware, or hardware, including the structural means disclosed in this specification and structural equivalents thereof, or in combinations of them. The invention can be implemented using one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results.

What is claimed is:

1. A method for defining a virtual patient population comprising:
obtaining a datum or data for each of multiple real subjects in a sample population;
acquiring one or more virtual measures for each of two or more virtual patients;
evaluating similarity between the virtual patients and the real subjects using a subset of the datum or data for at least two of the real subjects and a subset of the virtual measures for at least two of the virtual patients, each subset characterizing one or more features common to the at least two real subjects and the at least two virtual patients;
assigning a prevalence to each virtual patient based on the evaluation;
defining the virtual patient population as the two or more virtual patients according to their respective prevalences.

2. The method of claim 1, wherein the subset is all of the virtual measures or all of the data.

3. The method of claim 1, further comprising:
associating a datum or data for each of the multiple real subjects with one or more of the virtual measures for each of the virtual patients to identify features common to the virtual patients and the real subjects.

4. The method of claim 1, wherein assigning a prevalence to each virtual patient includes assigning a prevalence of zero to at least one virtual patient.

5. The method of claim 1, wherein assigning a prevalence to each virtual patient includes identifying at least one cluster of two or more virtual patients and assigning a same prevalence to each of the two or more virtual patients in the cluster.

6. The method of claim 1, wherein acquiring one or more virtual measures for each of two or more virtual patients includes using a model of a biological system to generate one or more virtual measures for each of the two or more virtual patients.

7. The method of claim 1, wherein the common features include one or more independent variables and one or more dependent variables.

8. The method of claim 7, wherein the common features include multiple independent or dependent variables, wherein at least one variable is a continuous variable.

9. The method of claim 7, wherein the one or more dependent variables include measurements of a biological feature at multiple time intervals.

10. The method of claim 1, wherein the common features include one or more categorical variables.

11. The method of claim 8, wherein evaluating the similarity between the two or more virtual patients and the real subjects includes identifying one or more combinations of the common features and characterizing each of the virtual patients and the real subjects in terms of the two or more combinations.

12. The method of claim 11, wherein identifying two or more combinations of the variables in the set of variables includes using a principle components analysis to identify principle components; and characterizing each of the virtual patients and the real subjects includes locating each of the virtual patients and the real subjects in a space defined by the principle components or by factors derived from the principle components.

13. The method of claim 7, wherein evaluating the similarity between the two or more virtual patients and the real subjects includes:
determining a correlation between the one or more independent variables and the one or more dependent. variables for the real subjects;
determining the correlation between the one or more independent variables and the one or more dependent variables for the virtual patients; and
comparing the correlation for the real subjects with the correlation for the virtual patients.

14. The method of claim 13, wherein determining a correlation for the real subjects includes:
expressing the one or more dependent variables as a first function of the one or more independent variables using data from the real subjects,
determining a correlation for the virtual patients includes expressing the one or more dependent variables as a second function of the one or more independent variables using data defining the virtual patients, and
comparing the correlation for the real subjects with the correlation for the virtual patients includes comparing the first and second functions.

15. The method of claim 14, wherein the first function is a first linear regression, the second function is a second linear regression, and comparing the first and second functions includes comparing a slope of the first linear regression with a slope of the second linear regression.

16. The method of claim 1, wherein evaluating similarity between the two or more virtual patients and the real subjects using the common features includes:
identifying two or more clusters of real subjects; and
assigning each of the two or more virtual patients to one of the two or more clusters.

17. The method of claim 8, wherein evaluating similarity between the two or more virtual patients and the real subjects using the common features includes
identifying two or more clusters of real subjects; and
calculating a distance between each of the two or more virtual patients and each of the two or more clusters of real subjects.

18. The method of claim 1, wherein the common features include at least one continuous dependent variable, and evaluating the similarity between the two or more virtual patients and the real subjects includes:
calculating one or more summary statistics for the continuous dependent variable for the real subjects;
calculating the one or more summary statistics for the continuous dependent variable for the virtual patients; and
comparing the one or more summary statistics for the real subjects with the summary statistics for the virtual patients.

19. The method of claim 18, wherein the one or more summary statistics include a measure of mean, mode, standard deviation, variance, skewness, or kurtosis for the continuous dependent variable.

20. The method of claim 1, wherein evaluating the similarity between the two or more virtual patients and the real subjects includes calculating a measure of goodness-of-fit between the common features for the virtual patients and the common features for the real subjects.

21. The method of claim 11, wherein evaluating the similarity between the two or more virtual patients and the real subjects includes calculating a measure of goodness-of-fit between the combinations of the common features for the virtual patients and the combinations of the common features for the real subjects.

22. The method of claim 20, wherein the measure of goodness-of-fit is selected from the group consisting of: Chi-square test, G-test, Analysis of Covariance (ANCOVA), Kolmogorov-Smimov test, weighted coefficient of determination.

23. The method of claim 20, wherein the measure of goodness-of-fit is a qualitative assessment of statistical properties of the common features for the virtual patients and the common features for the real subjects.

24. The method of claim 1, wherein assigning a prevalence to each virtual patient based on the evaluation includes:
matching each of the two or more virtual patients to one or more real subjects;
assigning a matching score to each of the two or more virtual patients based upon the matches; and
computing a prevalence for each virtual patient based upon its matching score.

25. The method of claim 24, wherein each matching score is based on a measure of distance between a virtual patient and a real subject in a space defined by the common features.

26. The method of claim 12, wherein assigning a prevalence to each virtual patient based on the evaluation includes:
matching each of the two or more virtual patients to one or more real subjects;
assigning a matching score to each of the two or more virtual patients, wherein each matching score is based on the distance between a virtual patient and a real subject in a space defined by the principle components or by factors derived from the principal component;, and
computing a prevalence for each virtual patient based upon its matching scores.

27. The method of claim 25, wherein the measure of distance weights the common features differently.

28. The method of claim 24, wherein matching each of the two or more virtual patients to one or more real subjects includes determining, for each of the two or more virtual patients, a distance to each of the one or more real subjects, assigning a matching score to each of the two or more virtual patients for each of the one or more real subjects that is matched includes, for each real subject, normalizing the distances of the virtual patients that match the real subject to define a normalized per subject distance and, for each virtual patient, summing the normalized per subject distances to define a virtual patient total score, and computing a prevalence includes normalizing the total scores for the two or more virtual patients to define a prevalence for each of the two or more virtual patients.

29. The method of claim 1, wherein assigning a prevalence to each virtual patient includes computing a weight based on the number and similarity of real subjects determined to be within a similarity threshold.

30. The method of claim 13, wherein assigning a prevalence to each virtual patient includes adjusting parameters of the correlation for the virtual patients to more closely approximate the correlation for the real subjects.

31. The method of claim 1, further comprising:
evaluating similarity between the virtual patient population and the sample population using the common features;
assigning a new prevalence to each virtual patient based on the similarity between the virtual patient population and the sample population; and
re-defining the virtual patient population as the two or more virtual patients according to their respective new prevalences.

32. The method of claim 31, wherein evaluating similarity between the virtual patient population and the sample population includes calculating a measure of goodness-of-fit between the common features for the virtual patients according to their respective prevalences and the common features for the real subjects.

33. The method of claim 32, wherein the measure of goodness-of-fit is selected from the group consisting of: Chi-square test, G-test, Analysis of Covariance (ANCOVA), Kolmogorov-Smimov test, weighted coefficient of determination.

34. The method of claim 31, wherein the common features include at least one continuous dependent variable; and evaluating the similarity between the virtual patient population and the sample population includes
calculating one or more summary statistics for the continuous dependent variable for the real subjects;
calculating the one or more summary statistics for the continuous dependent variable for the virtual patients according to their respective prevalences; and
comparing the one or more summary statistics for the real subjects with the summary statistics for the virtual patients.

35. The method of claim 32, wherein the measure of goodness-of-fit is a qualitative review of the statistical properties of the common features for the virtual patients and the real subjects.

36. A method for defining a virtual patient population comprising:
obtaining a datum or data for each of multiple real subjects in a sample population;
acquiring one or more virtual measures for one or more virtual patients;
evaluating similarity between the one or more virtual patients and the real subjects using a subset of the datum or data for at least two of the real subjects and a subset of the virtual measures for at least one of the virtual patients, each subset characterizing one or more features common to the at least two real subjects and the at least one virtual patient;
performing the actions of:
(a) building one or more additional virtual patients based on the evaluation and
(b) re-evaluating similarity between the one or more virtual patients together with the one or more additional virtual patients and the real subjects using the common features;
assigning a prevalence to each virtual patient based on the re-evaluation; and
defining the virtual patient population as the two or more virtual patients according to their respective prevalences.

37. The method of claim 36, wherein building one or more additional virtual patients based on the evaluation includes:
identifying hypothetical values of the common features that have high similarity to one or more real subjects and low similarity to one or more virtual patients;
generating virtual measures for one or more additional virtual patients, wherein the virtual measures are similar to the hypothetical values.

38. The method of claim 36, further comprising:
repeating the performance of steps (a) and (b) one or more times; and
wherein assigning a prevalence to each virtual patient based on the re-evaluation includes assigning a prevalence to each virtual patient based on the re-evaluation in a repeated performance of steps (a) and (b).

39. The method of claim 1, further comprising:
evaluating similarity between the virtual patient population and the sample population using a new subset of the datum or data for at least two of the real subjects and a new subset of the virtual measures for at least two of the virtual patients, each new subset characterizing one or more different features common to the at least two real subjects and the at least two virtual patients;
assigning a new prevalence to each virtual patient based on the similarity between the virtual patient population and the sample population using the different common features; and
re-defining the virtual patient population as the two or more virtual patients according to their respective new prevalences.
